(19) United States
(12) Patent Application Publication
(10) Pub. No.: US 2025/0329001 A1
(43) Pub. Date: Oct. 23, 2025

(54) REFERENCE WHITE TONE MAPPING OPTIMIZATION

(71) Applicant: Apple Inc., Cupertino, CA (US)

(72) Inventors: Ronan J. BOITARD, Sunnyvale, CA (US); Benjamin L. BODNER, Rochester, NY (US); Alexander G. CARPENTER, Cupertino, CA (US); Michael P. OLNEY, Sunnyvale, CA (US); Rahul GOPALAN, San Jose, CA (US); Nicolas P. BONNIER, Mountain View, CA (US); Jackson K. ROLAND, San Jose, CA (US)

(21) Appl. No.: 19/185,544

(22) Filed: Apr. 22, 2025

Related U.S. Application Data
(60) Provisional application No. 63/637,765, filed on Apr. 23, 2024.
(60) Provisional application No. 63/637,865, filed on Apr. 23, 2024.

(51) Int. Cl. G06T 5/92

(52) U.S. Cl. CPC G06T 5/92; G06T 2207/20208

(57) ABSTRACT

A method for generating image specific global tone curves is disclosed. A reference white tone mapping optimization module generates a global tone curve based on parameters that account for properties of an input image and a target device on which to reproduce an output image generated from the input image using the global tone curve. Such parameters may include a peak value and a reference white value of the input image and a headroom value of the target device. Some parameters, which can be configured or derived, may include a standard-definition range exposure parameter and a high definition range to standard-definition range mix parameter that influence the position and shape of the global tone curve to allow for soft clipping of highlight values of the input image. The global tone curve may include a linear segment and a curved segment, such as a Bézier curve segment.

### CROSS-REFERENCE TO RELATED APPLICATIONS

The present application claims the benefit of U.S. Provisional Application No. 63/637,765, entitled “REFERENCE WHITE TONE MAPPING OPTIMIZATION,” filed Apr. 23, 2024, and claims the benefit of U.S. Provisional Application No. 63/637,865, entitled “REFERENCE WHITE TONE MAPPING OPTIMIZATION,” filed Apr. 23, 2024, the contents of all of which are incorporated by reference herein in their entirety for all purposes.

### FIELD OF INVENTION

The embodiments described herein set forth techniques for generating image specific global tone curves based on properties of an input image and of a target device. The image specific global tone curves can also depend on configurable and/or derived parameters regarding standard dynamic range (SDR) and high dynamic range (HDR) properties for images and/or for devices to which to output images.

### BACKGROUND

The dynamic range of an image refers to a range of pixel values between an image's lightest and darkest parts. Notably, image sensors capture a limited range of light levels, also referred to as luminance, in a single exposure of a scene, e.g., relative to what humans are able to perceive from the same scene. This limited range is typically referred to as standard dynamic range (SDR) in the world of digital photography.

Improvements in sensors and in photography techniques have enabled wider ranges of light levels to be captured (referred to herein as high dynamic range (HDR)). Such images can be obtained by (1) capturing multiple “bracketed” images, i.e., images with different exposures, and then (2) combining the bracketed images into a single image that incorporates different aspects of the different exposures. In this regard, a single HDR image can include a wider dynamic range of captured light levels in comparison to what otherwise can be captured in an individual exposure.

Display devices capable of displaying a wider range of light levels captured in HDR images are becoming more accessible due to advancements in design and manufacturing technologies; however, a majority of display devices currently in use (and continuing to be manufactured) are only capable of displaying a more limited range of light levels, e.g., optimized for display of SDR images or providing an extended dynamic range (EDR) above SDR only but below full HDR capability. Similarly, additional output devices such as printers can only provide for a more limited range of color values. Consequently, captured and/or generated images need to be adjusted when output to a target device for reproduction by the target device.

Accordingly, what is needed is a technique to manipulate an image efficiently and accurately for output to a target device.

### SUMMARY OF INVENTION

Representative embodiments described herein set forth techniques for generating an image specific global tone curve, which can be used to map an input image to an output image to provide to a target device for reproduction by the target device. The image specific global tone curve can be based on a reference white value of the input image, where the reference white value represents a first grey level of the input image to appear white. The image specific global tone curve can also be based on a peak value of the input image, where the peak value represents a highest valued light level for a unit, e.g., a pixel, of the input image. The image specific global tone curve can further be based on a headroom value of a target device to which the input image is intended to be mapped for output, e.g., to display. The headroom value of the target device represents a difference between a reference light level for the target device and a maximum light level of the target device, expressed as a factor (or ratio) between the light levels, e.g., a fraction between 0 and 1.

The image specific global tone curve can be generated and stored with the input image for subsequent generation of an output image that can be provided to the target device. In some embodiments, the input image includes a high-definition range image, the target device includes a standard-definition range only capable display, a limited capability high-definition range display, or a full capability high-definition range display, and the image specific global tone curve provides a mapping of the high-definition range input image to an standard-definition range only (or a limited capability high-definition range or full capability high-definition range) output image capable of being displayed on the standard-definition range only (or limited capability high-definition range or full capability high-definition range) target device. The image specific global tone curve can be based on one or more configurable and/or derived standard-definition range and/or high-definition range parameters.

In some embodiments, the image specific global tone curve is based on a standard-definition range exposure parameter that indicates how to scale input image content, e.g., for a high-definition range input image, to create space for highlights to be displayed on a standard-definition range only target device. In some embodiments, the standard-definition range exposure parameter causes a scaling, shift, and/or reshaping of the image specific global tone curve when a headroom value of the target device falls within a particular range of values. In some embodiments, the image specific global tone curve is further based on an high-definition range to standard-definition range mix parameter that determines a rate at which changes to the image specific global tone curve by the standard-definition range exposure parameter occur, e.g., to reduce or increase scaling, shifts, and/or reshaping of the image specific global tone curve due to the standard-definition range exposure parameter. In some embodiments, the image specific global tone curve includes a linear, monotonically increasing segment and a curved, monotonically increasing segment.

In some embodiments, the curved segment is based on a second-order (or higher order) Bézier curve function, which can be characterized by multiple parameters. In various embodiments, the Bézier curve function is parameterized based on a first point P₀ representing the reference white value of the input image and a corresponding reference white value of the target device, a second point P₂ representing the peak value of the input image and a maximum output level of the target device, and a third point P₁ representing a control point that determines a shape of the Bézier curve function between the first point P₀ and the second point P₂. A slope (or shape) of the Bézier curve function can vary based on different factors, e.g., headroom values of the target device and/or peak input image values can influence the slope (shape) of the Bézier curve function.

In some embodiments, the image specific global tone curve includes a linear, monotonically increasing segment, a curved, monotonically increasing segment, and an additional linear, monotonically increasing segment. In some embodiments, the curved, monotonically increasing segment is based on a soft-knee curve function. In some embodiments, a series of image specific global tone curves are generated based on a series of input images, each successive input image representing a frame from an input video intended to be reproduced by a target device.

Other embodiments include a non-transitory computer readable storage medium configured to store instructions that, when executed by at least one processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates an overview of an exemplary computing device that can be configured to perform the various techniques described herein, according to some embodiments.

FIG. 2A illustrates a diagram of an exemplary technique to process an input image to generate an output image based on an image specific global tone curve that accounts for properties of the input image and properties of a target device on which to render the output image, according to some embodiments.

FIG. 2B illustrates a diagram of an exemplary generalized version of the technique illustrated in FIG. 2A, according to some embodiments.

FIG. 2C illustrates a diagram of an exemplary technique to process one or more input frames of a video to generate one or more corresponding output frames based on image specific global tone curves determined for each frame that accounts for properties of the one or more input frames and of a target device on which to reproduce the output frames, according to some embodiments.

FIG. 2D illustrates a diagram of an exemplary variant, referred to as the compressor variation, of the reference white tone mapping optimization (RWTMO) modules illustrated in FIGS. 2A to 2C, that provides reduced complexity processing, according to some embodiments.

FIG. 3A illustrates exemplary image specific tone mapping curves including a Bézier curve segment and based on properties of the input image and of a target device, according to some embodiments.

FIG. 3B illustrates an example of a standardized, generalized tone mapping curve, according to some embodiments.

FIGS. 3C, 3D, and 3E illustrate examples of different normalizations applied to a Bézier curve segment of a tone mapping curve, according to some embodiments.

FIG. 3F illustrates an example of adapting a standard dynamic range (SDR) exposure parameter based on property of an input image, according to some embodiments.

FIGS. 3G and 3H illustrates exemplary tone mapping curves adapted based on various properties of an input image and/or of a target device, according to some embodiments.

FIG. 31 illustrates an exemplary extended tone mapping curve without clamping, according to some embodiments.

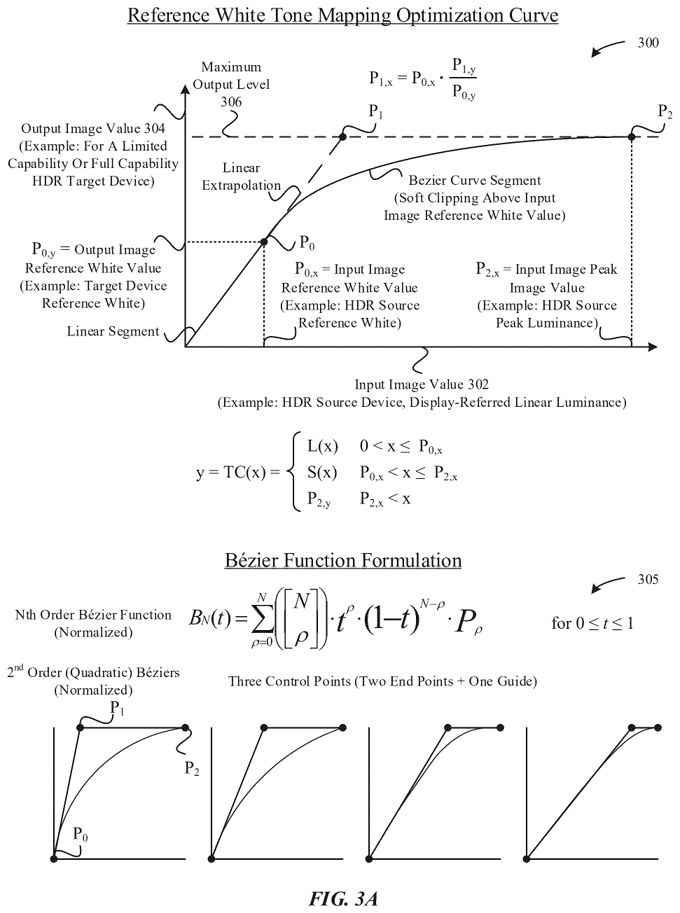

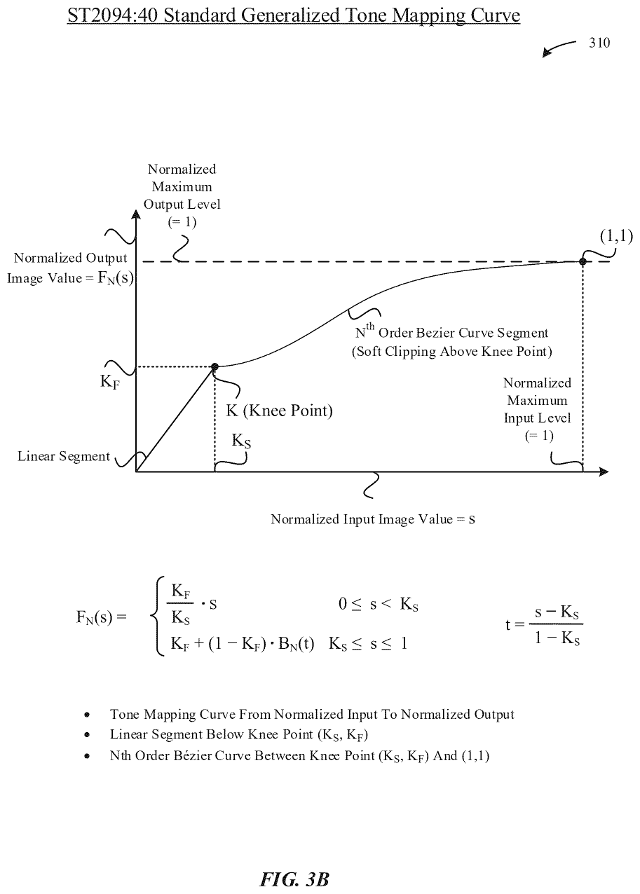

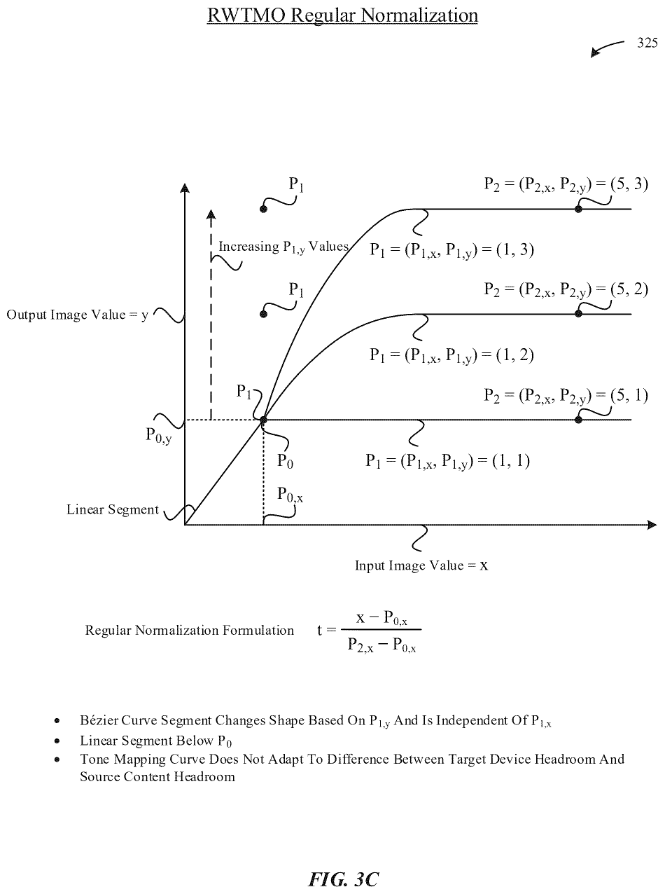

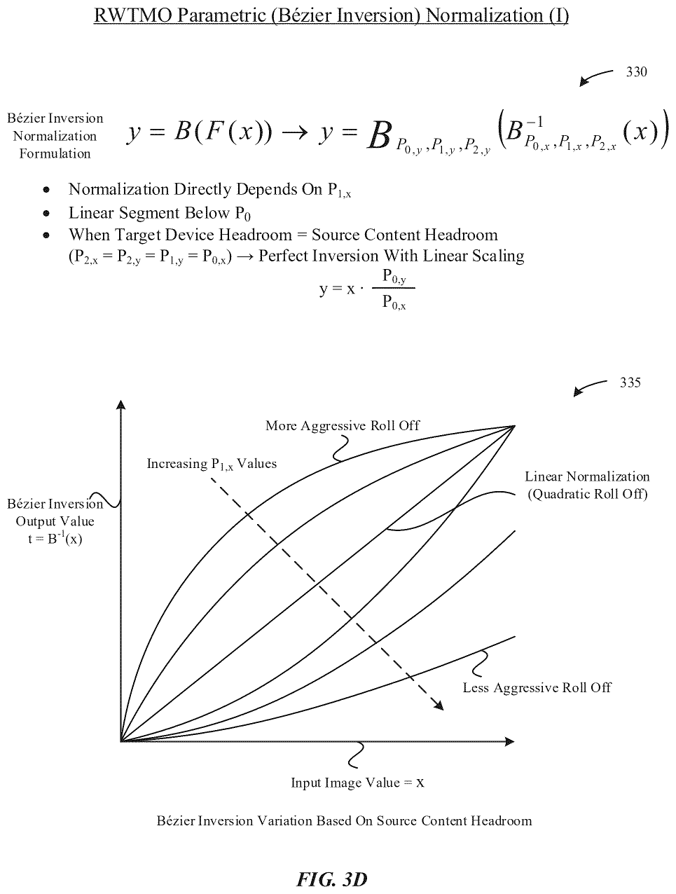

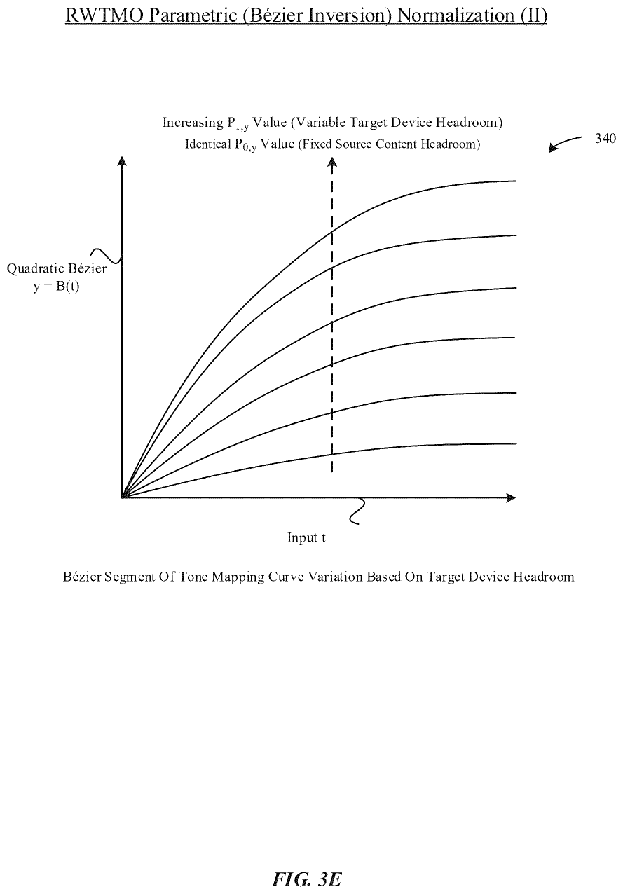

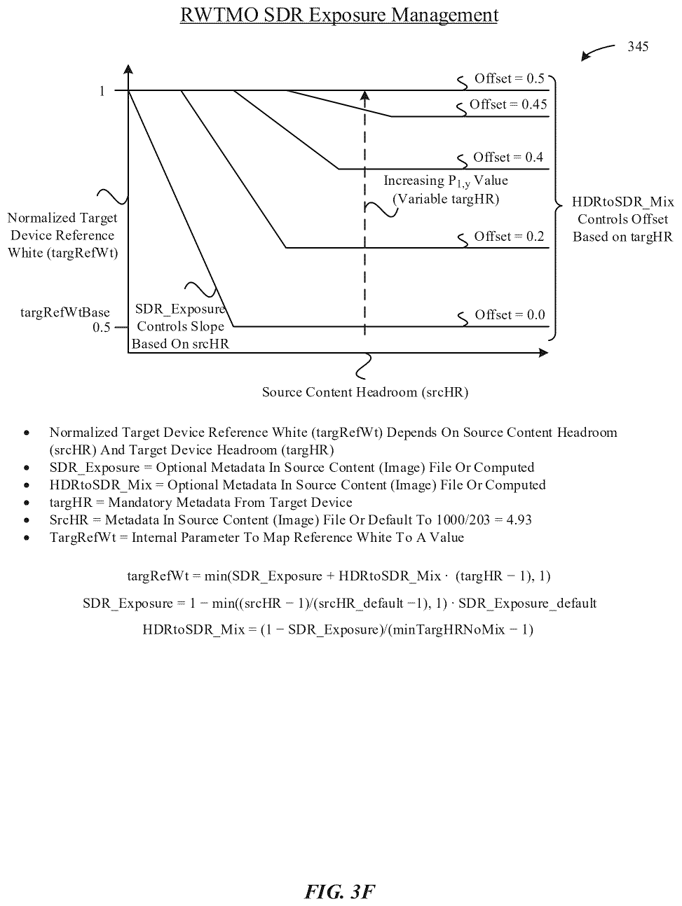

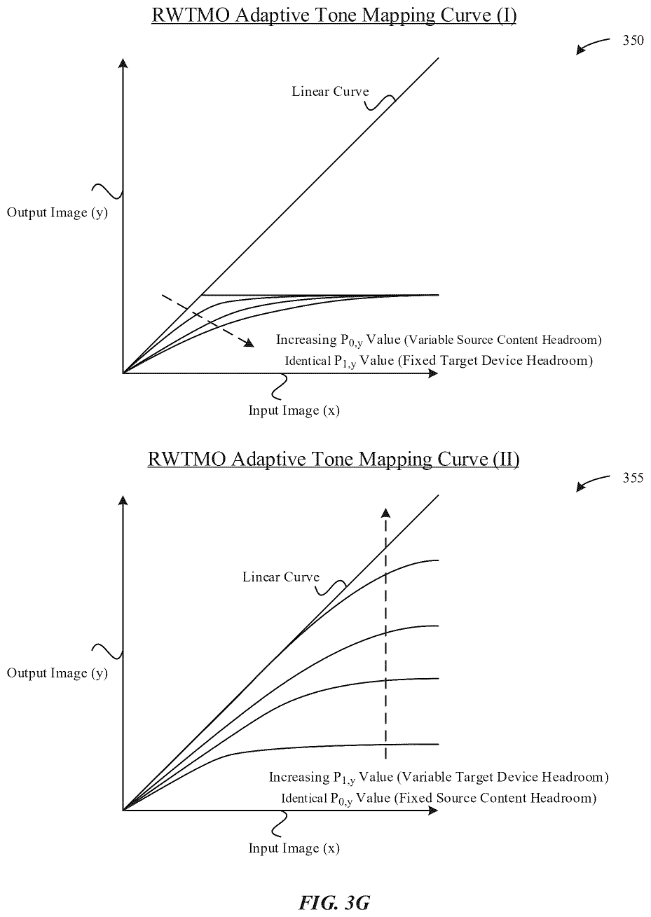

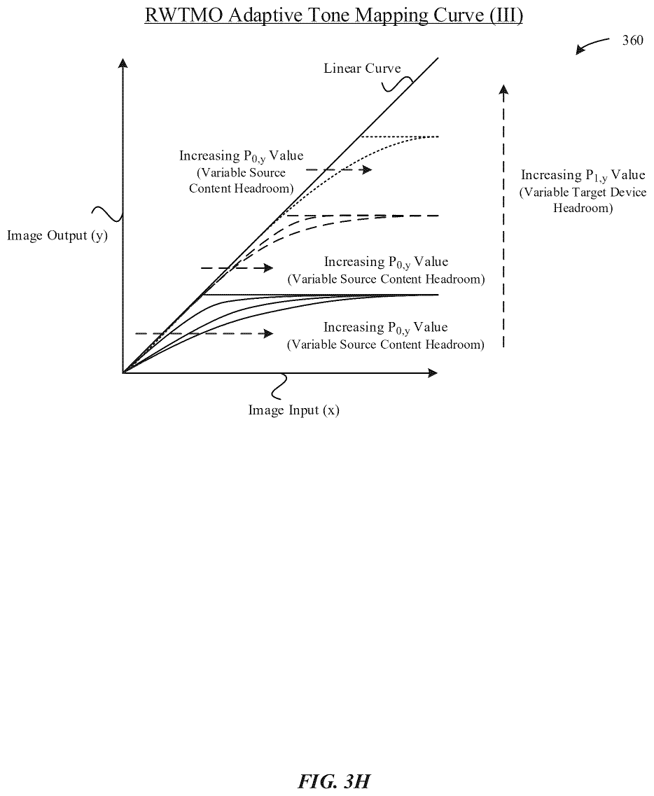

FIG. 3J illustrates an exemplary compressor variation tone mapping curve, according to some embodiments.

FIGS. 4A, 4B, and 4C illustrate examples of adaption of tone mapping curves based on different values of a provided or derived SDR exposure parameter, according to some embodiments.

FIGS. 4C, 4D, and 4E illustrate examples of adaption of tone mapping curves based on different values of an SDR exposure parameter and an HDR to SDR mix parameter, according to some embodiments.

FIG. 5A illustrates a diagram of an exemplary technique to process an HDR image to output to an SDR only capable target device, according to some embodiments.

FIGS. 5B and 5C illustrate examples of adaptive tone mapping curves for processing HDR input images to SDR output images, according to some embodiments.

FIG. 6A illustrates an exemplary generic tone mapping curve, according to some embodiments.

FIGS. 6B, 6C, and 6D illustrate examples of interpolating a target device reference white value, according to some embodiments.

FIG. 7 illustrates a flowchart of a representative method for generating an image specific global tone curve based on properties of an input image and of a target device, according to some embodiments.

FIG. 8 illustrates a detailed view of a computing device that can be used to implement the various techniques described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments can be practiced without some or all of these specific details. In other instances, well-known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting such that other embodiments can be used, and changes can be made without departing from the spirit and scope of the described embodiments.

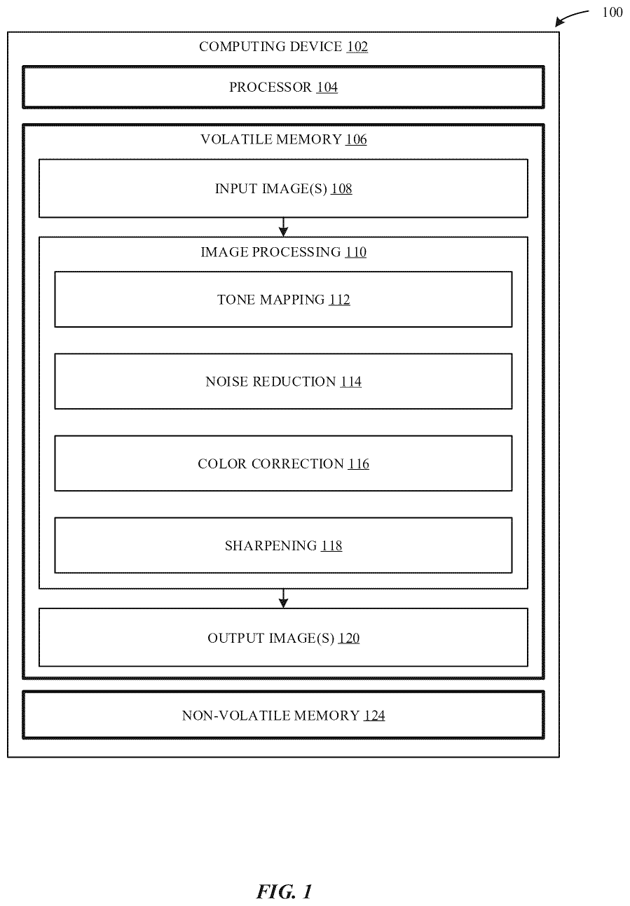

Representative embodiments set forth herein disclose techniques for generating image specific global tone curves based on properties of an input image and of a target device. For example, tone mapping curves can be parameterized based on a combination of a reference white level of the input image, a peak white level of the input image, and a headroom capability of the target device. The image specific global tone curves can also depend on configurable and/or derived parameters regarding standard dynamic range (SDR) and high dynamic range (HDR) properties for images and/or for devices to which to output images. A more detailed description of these techniques is provided below in conjunction with FIGS. 1 through 8.

FIG. 1 illustrates an overview 100 of a computing device 102 that can be configured to perform the various techniques described herein. As shown in FIG. 1, the computing device 102 can include a processor 104, a volatile memory 106, and a non-volatile memory 124. It is noted that additional example hardware components that can be included in the computing device 102 are illustrated in FIG. 7, and that those components are omitted from the illustration of FIG. 1 for simplification purposes. For example, the computing device 102 can include additional non-volatile memories (e.g., solid-state drives, hard drives, etc.), other processors (e.g., a multi-core central processing unit (CPU)), a graphics processing unit (GPU), and so on). According to some embodiments, an operating system (OS) (not illustrated in FIG. 1) can be loaded into the volatile memory 106, where the OS can execute a variety of applications that collectively enable the various techniques described herein to be implemented. For example, these applications can include an image processing module 110 (and its internal components), a tone mapping module 112, which can include an image specific global tone curve generator, one or more compressors (not illustrated in FIG. 1), and so on.

As shown in FIG. 1, the volatile memory 106 can be configured to receive one or more input images 108. The input images 108 can be provided, for example, by a digital imaging unit (not illustrated in FIG. 1) that is configured to capture and optionally process digital images. According to some embodiments, an input image 108 includes a collection of pixels, where each pixel in the collection of pixels includes a group of sub-pixels (e.g., a red sub-pixel, a green sub-pixel, a blue sub-pixel, an alpha sub-pixel, etc.). It is noted that the term “sub-pixel” used herein can be synonymous with the term “channel.” It is also noted that the input images 108 can have different resolutions, layouts, bit-depths, and so on, without departing from the scope of this disclosure. Example input images 108 include standard dynamic range (SDR) images that can be captured with a single exposure of a scene, and high dynamic range (HDR) images that can be captured using multiple exposures of a scene. For example HDR images can be generated by using exposure bracketing to change the light levels received with a sensor of the source device used to capture SDR images. The imaging processing module 110 of the computing device 102 (or in some cases processing in the source device) can combine elements of multiple SDR images to generate an HDR image. Input images 108 that are processed using the tone mapping module 112 can include goth SDR images and HDR images. It is noted that the input images 108 discussed herein are not limited to SDR images and/or HDR images. For example, the input images 108 can represent any form of digital image (e.g., scanned images, computer-generated images, etc.) without departing from the scope of this disclosure.

As shown in FIG. 1, the input images 108 can (optionally) be processed by various other modules, such as a noise reduction module 114 (e.g., configured to reduce global/local noise in the input image), a color correction module 116 (e.g., configured to perform global/local color corrections in the input image), and a sharpening module 118 (e.g., configured to perform global/local sharpening corrections in the input image). It is noted that image processing module 110 is not limited to the aforementioned processing modules, and that the image processing module 110 can incorporate any number of processing modules, configured to perform any processing of/modifications to the input images 108, without departing from the scope of this disclosure.

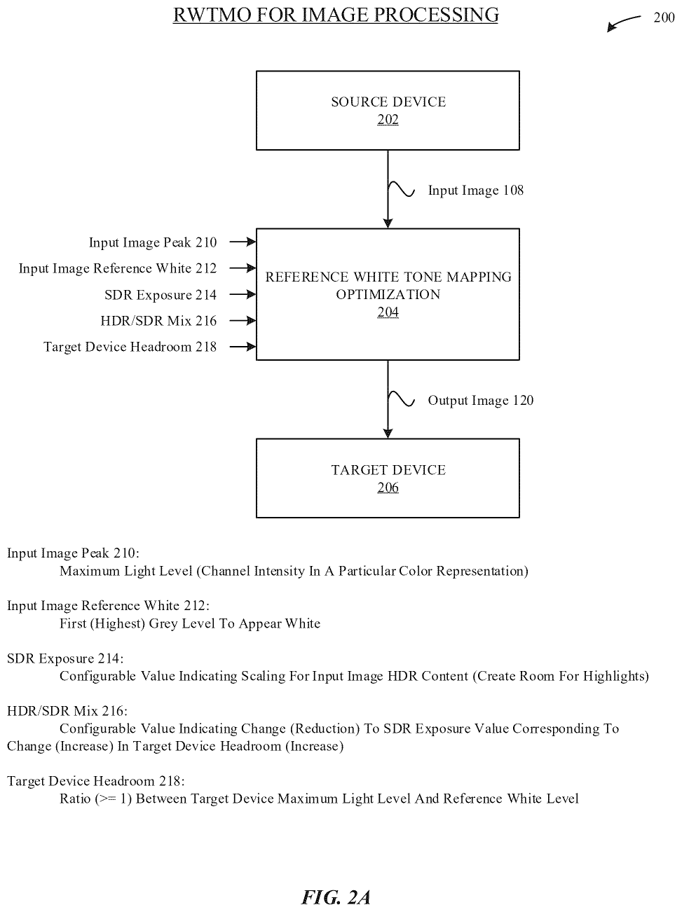

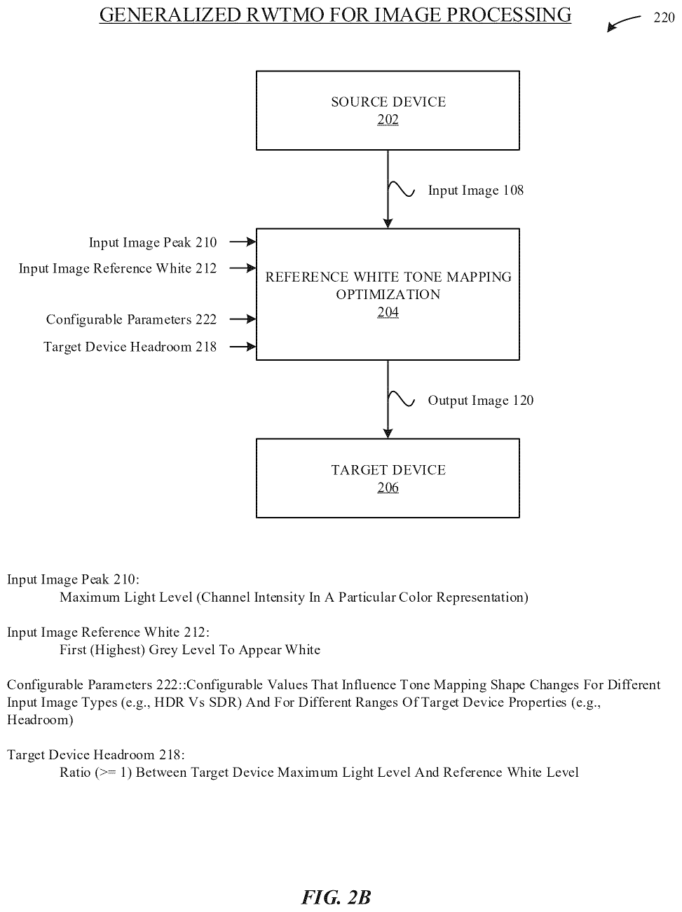

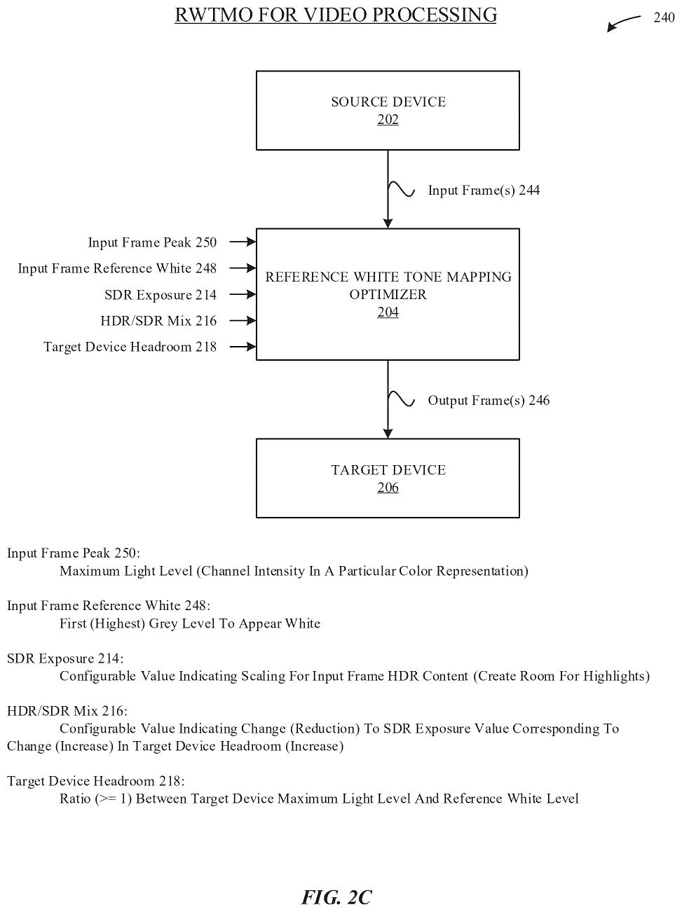

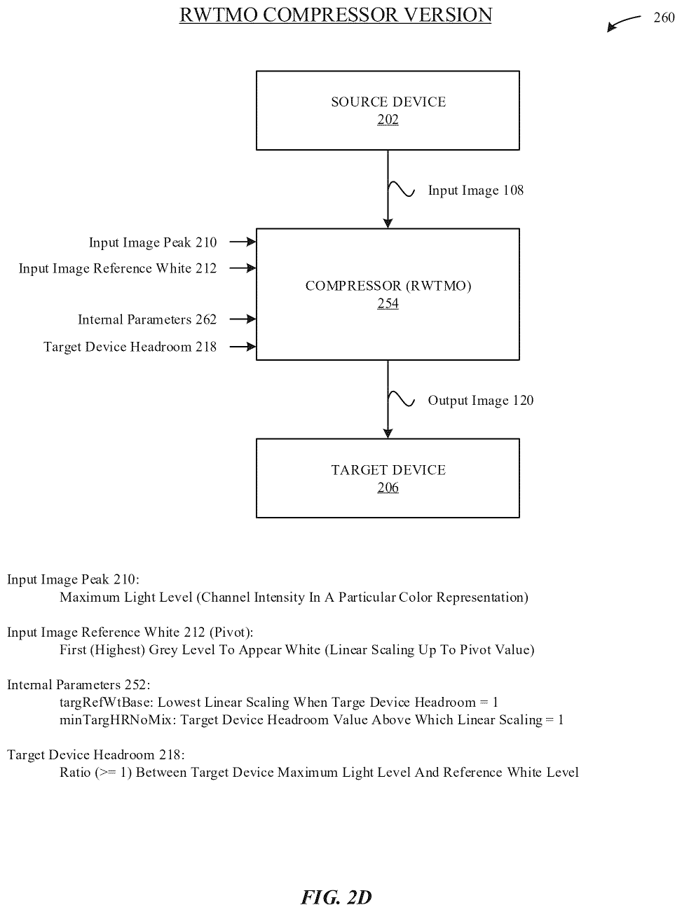

Accordingly, FIG. 1 provides a high-level overview of different hardware/software architectures that can be implemented by computing device 102 in order to carry out the various techniques described herein. A more detailed breakdown of these techniques will now be provided below in conjunction with FIGS. 2A to 8.

FIG. 2A illustrates a diagram 200 of. an exemplary technique to process an input image 108 to generate an output image 120 based on an image specific global tone curve that accounts for properties of the input image 108 and properties of a target device 206 on which to render the output image 120. A global tone curve (or mapping) maps an input pixel value (e.g., an RGB triplet) to an output pixel value (e.g., a corresponding RGB triplet) independent of a particular position of the input pixel in the input image 108. A global tone curve can include a three-dimensional look-up table (LUT), where each dimension corresponds to a color, e.g., red (R), green (G), or blue (B), of a pixel. Alternatively, the global tone curve can correspond to a one dimensional curve, e.g., based on a light intensity level for a channel in a given color representation. The image specific global tone curve of a reference white tone mapping optimization (RWTMO) module 204 uses a one-dimensional image specific global tone curve. Alternatively, a local tone curve (or mapping) maps values of an input pixel triplet to different values of a corresponding output pixel triplet depending on a spatial position of the input pixel and on additional contextual information, such as values for one or more pixels near to the input pixel in the input image 108 and/or based on values for one or more corresponding pixels for corresponding input images 108 that may precede and/or follow the input image 108 in a series of input images 108 (e.g., for processing a video that includes a sequence of input images 108). Thus spatial information and/or temporal information can be used to change local tone mapping, while global tone mapping, generally, remains static.

For a fixed global tone curve, the shape of the curve can be fixed and cannot change. For a global tone curve based on metadata, the shape of the curve can be defined using a set of parameters, as discussed herein for the image specific global tone curve generated by the RWTM O module 204. Additionally, a global tone curve can be based on statistics of the input image, such as a statistical histogram of values of pixels of the input image, a maximum value of the pixels, a minimum value of the pixels, etc. At each sampling point on the global tone curve, a scaling factor is obtained. If each color channel, e.g., each RGB channel uses a different scaling factor, then the global tone curve may not preserve color values or saturation values of the pixels when mapping the input image to an output image. If only luminance values (or luma values) are used to sample a scaling factor, then the tone mapping of the corresponding global tone curve can be consistent across different color spaces but may be inconsistent across different colors. For the image specific global tone curve generated by the RWTM O module 204, a maximum value RGB pixel sample can be used to determine a scaling factor, which can provide consistent mapping across different colors, but can result in inconsistent mapping across different color spaces. Additionally, for the image specific global tone curve generated by the RWTM O module 204, color saturation values of pixels may be unchanged by the mapping. Alternative mappings may mix color channels to achieve different saturation levels, e.g., desaturation or boosted saturation, to provide different color results. In some embodiments, the RWTM O module 204 can be configured to provide tone mapping with one or more different resulting properties, e.g., using independent RGB scaling, using luma/luminance value scaling, using scaling based on a maxRGB value, or the like.

As shown in FIG. 2A, an RWTMO module 204 receives an input image 108 from a source device 202, e.g., a digital camera, a scanner, a computing device that generates images, etc., and provides an output image 120 to a target device 206, e.g., a display, a monitor, a television, a projector, a printer, etc. The RWTM O module 204 generates the output image 120 from the input image using an image specific global tone curve generated by the RWTM O module 204. The image specific global tone curve can be based on multiple parameters, includes some that are image specific, and other that are configurable and used for not image specific. In some embodiments, the RWTM O module 204 determines the image specific global tone curve based on an input i mage peak value 210 and an input image reference white value 212, both of which depend on properties of one or more pixels of the input image 108. The input image peak value 210 can represent a maximum light level included in the input image 108. The input image reference white value 212 can represent a first (highest) grey level of the input image 108 that appears white (or is intended to be displayed as white). The RWTM O module 204 also determine the image specific global tone curve based on a target device headroom value 218, which depends on properties of the target device 206. The target device headroom value 218 can represent a ratio between a maximum (peak) display light value capability of the target device 206 and a reference white level (SDR display luminance) setting of the target device 206. The target device headroom value 218 can be defined to be a ratio that is greater than or equal to one. In some embodiments, the RWTM O module 204 determines the image specific global tone curve based on one or more additional internal (fixed, configurable, or derived) parameter values, such as an SDR exposure parameter 214 value and/or an HDR to SDR mix parameter 216 value. The SDR exposure parameter 214 value can represent a configurable (or derived) parameter value that indicates scaling to apply to HDR content of the input image 108, e.g., in order to create room for displaying highlights of the input image 108 when mapped to the output image 120 for display on the target device 206. The HDR to SDR mix parameter 216 value can represent a configurable (or derived) parameter value that indicates changes (e.g., reducing the effect) for the SDR exposure parameter 214 value corresponding to a change (e.g., increase) in target device headroom values 218.

The RWTMO module 204 provides a means to map color tonal values of the input image 108 to manage specular highlights to fit into display (or reproduction) capabilities of the target device 206. Specular highlight values of the input image 108 that are above the input image reference white value 212 can be compressed using soft clipping (as described and shown further herein). The RWTMO module 204, in some embodiments, can have limited (or no) impact on lower level pixels, e.g., minimal or no manipulation of shadow values and mid-tone values (or limited or no impact on pixels below a minimum light value, e.g., a reference white value).

FIG. 2B illustrates a diagram 220 of an exemplary generalized version of the technique illustrated in FIG. 2A. The RWTM O module 204 of FIG. 2B generates an image specific global tone curve based on properties of the input image 108, e.g., the input image peak value 210 and the input image reference white value 212, and on at least one property of the target device 206, e.g., the target device headroom value 218. The RWTM O module 204 of FIG. 2B further generates the image specific global tone curve based on one or more configurable (or derived) parameters 222, which can be used to influence a shape of the tone mapping to accommodate different types of input images 108 and for different values of properties, e.g., headroom, of a target device 206 to which output images 120 are formatted for reproduction.

FIG. 2C illustrates a diagram 240 of an exemplary technique to process one or more input frames 244 of a video to generate one or more corresponding output frames 246 based on image specific global tone curves determined for each frame that accounts for properties of the one or more input frames 244 and at least one property of a target device 206 on which to reproduce the output frames. The RWTMO module 204 of FIG. 2C generates an image specific global tone curve for each input frame 244 to apply and generate a corresponding output frame 246. The image specific global tone curve for a particular input frame 244 can depend on an input frame peak value 250, an input frame reference white value 248, a target device headroom value 218, and on additional configurable (or fixed or derived) parameter values, such as an SDR exposure parameter value 214 and/or an HDR to SDR mix parameter value 216. In some embodiments, parameters used by the RWTM O module 204 to generate the image specific global tone curves can be adapted to video-based metadata and/or to statistics of the input frames 244. In some embodiments, image statistics used for input frames 244 can be identical to those used for single input images 108 but adapted at a temporal level to account for differences between successive (or sets of) input frames 244. For example, in some embodiments, metadata (parameter values) used to generate the image specific global tone curves can be constant across a particular clip, scene, or set of frames, e.g., to provide a consistent appearance in the set of output frames 246. In some embodiments, metadata parameter values and/or parameter statistics can be filtered over time to produce a sequence of image specific global tone curves that result in output frames 246 that avoid abrupt changes in appearance when reproduced by the target device 206.

FIG. 2D illustrates a diagram 260 of another exemplary technique to process an input image 108 to generate an output image 120 using an image specific global tone curve that depends on i) one or more properties of the input image 108, e.g., input image peak value 210, input image reference white value 212, input image headroom, ii) one or more properties of the target device 206 with which to reproduce the output image 120, e.g., target device headroom 218, and iii) one or more internal parameters 252. In some embodiments, the one or more internal parameters 262 include i) a targRefWtBase parameter value that indicates a lowest linear scaling for the image specific global tone curve when the target device headroom 218 has a value of one and ii) a minTargHRNoMix parameter value that indicates the target device headroom 218 value above which linear scaling equal to one is to be used. The input image peak 210 value, the input image reference white 212 value (also referred to as a pivot point value), and the target device headroom value 218 can all influence the shape of the image specific global tone curve determined by the compressor module 254. Details of the image specific global tone curves generated by the compressor module 254 are described further herein at FIG. 3J.

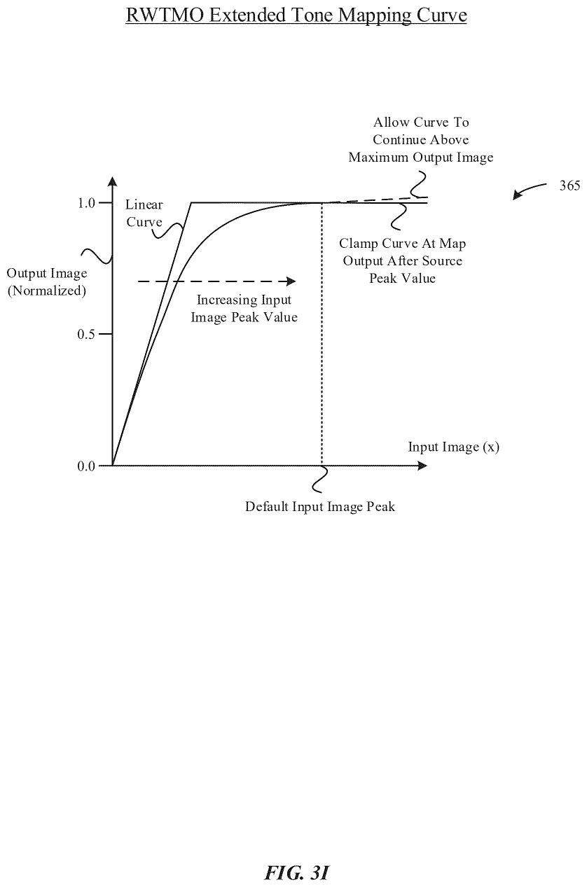

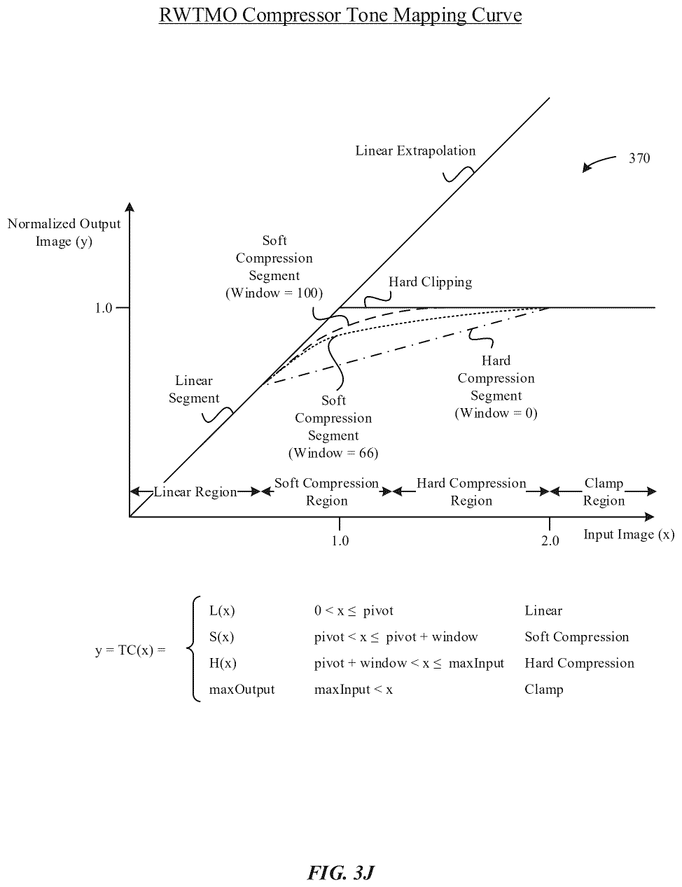

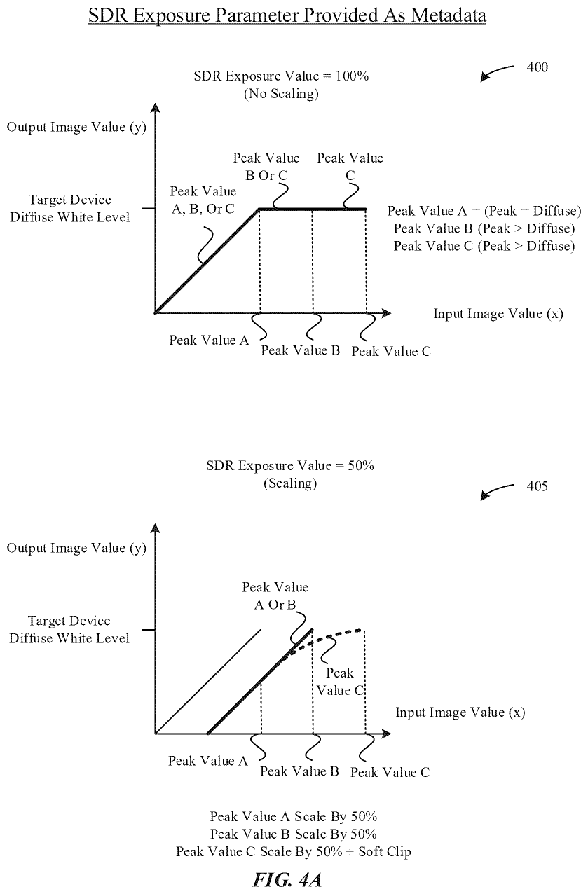

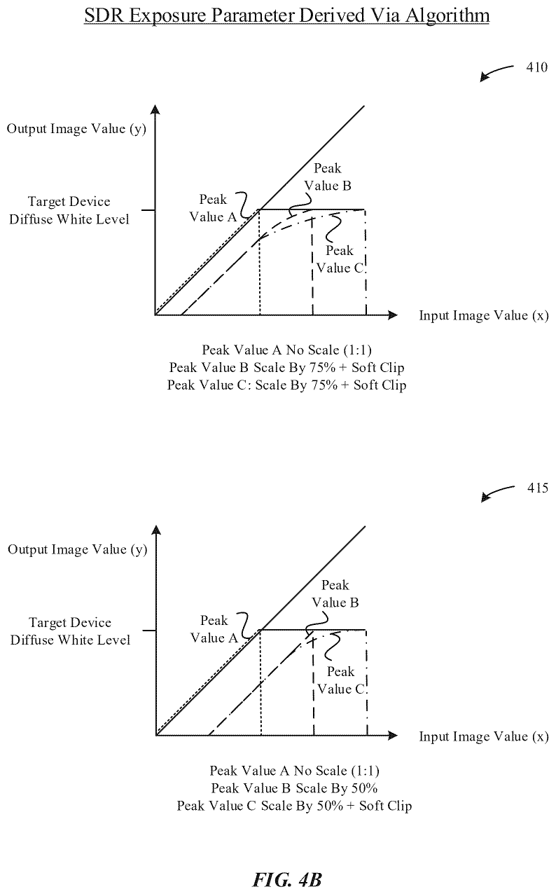

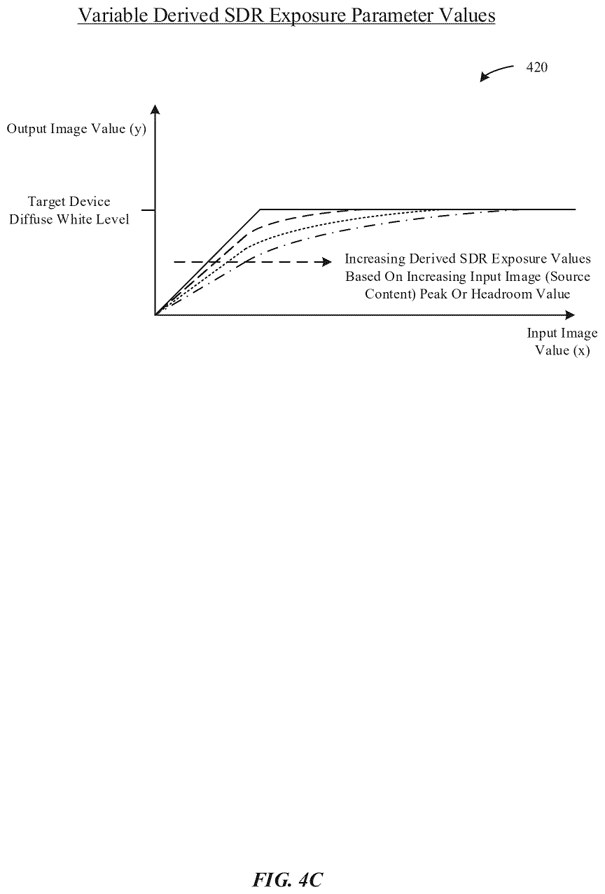

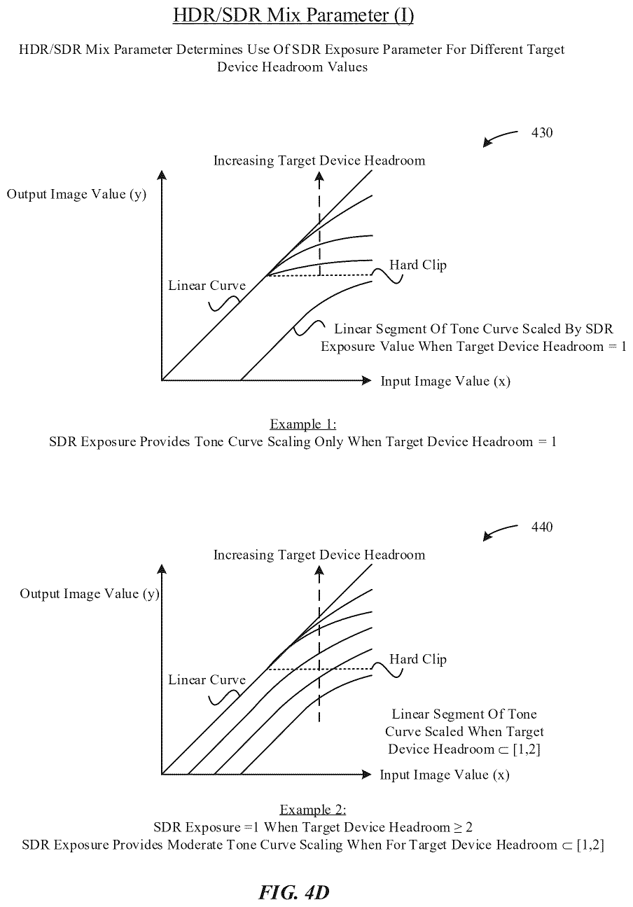

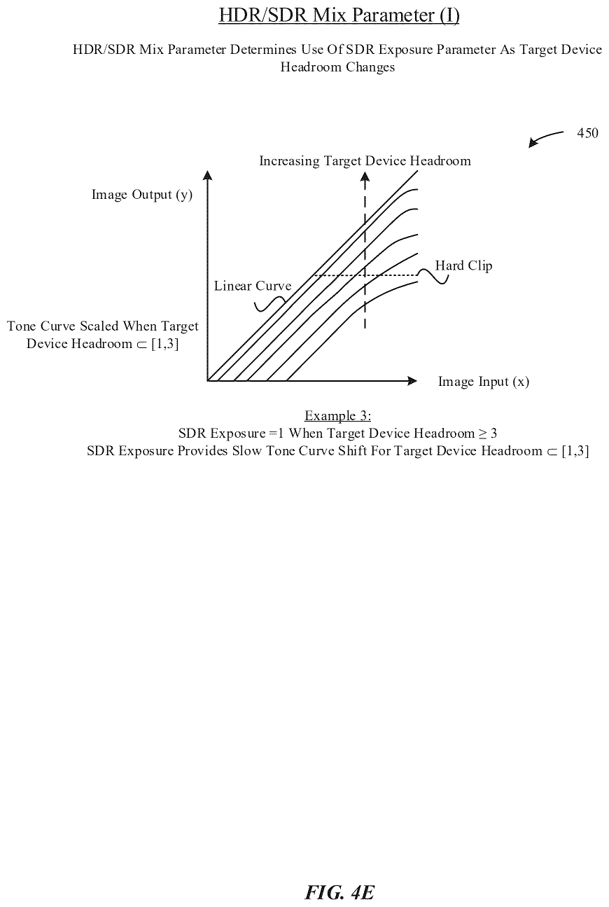

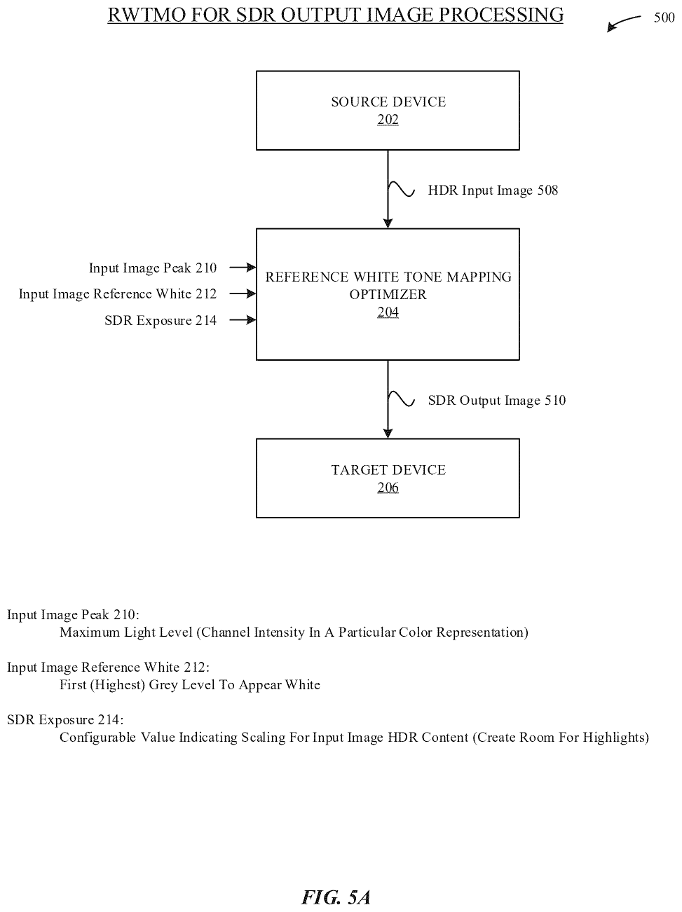

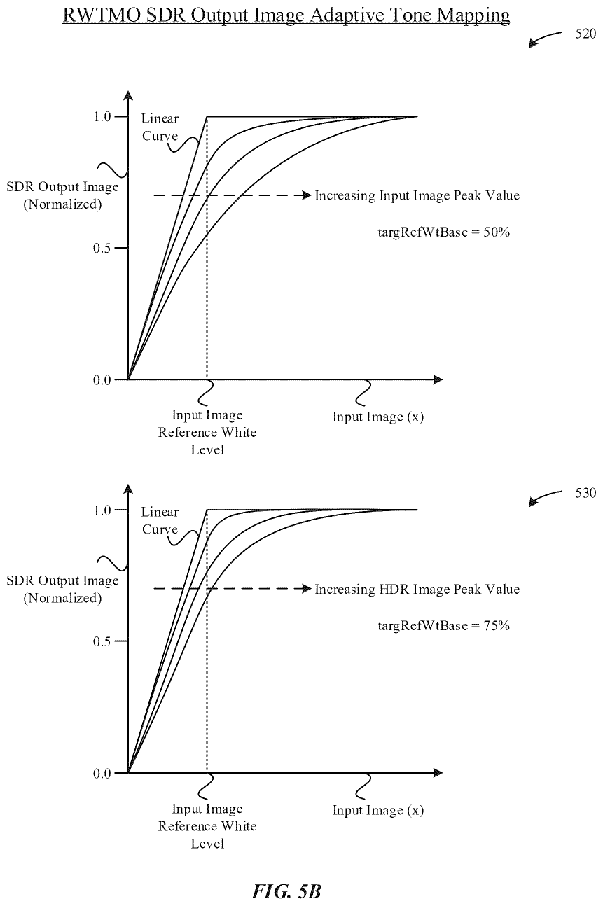

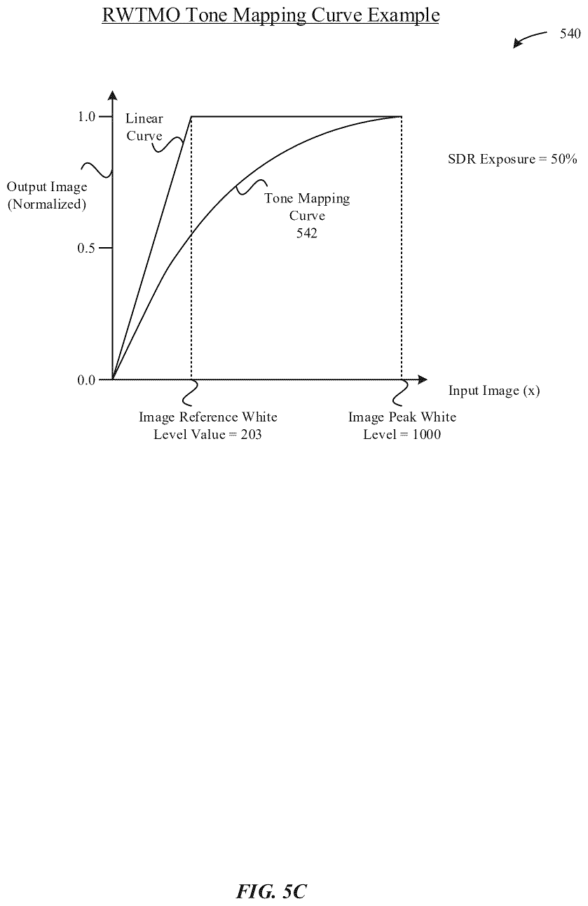

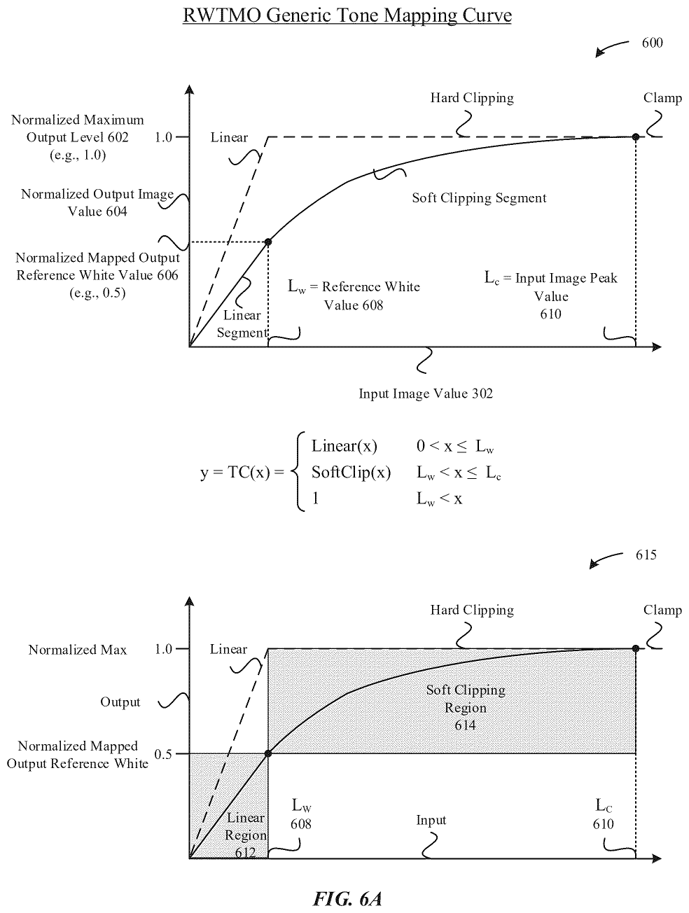

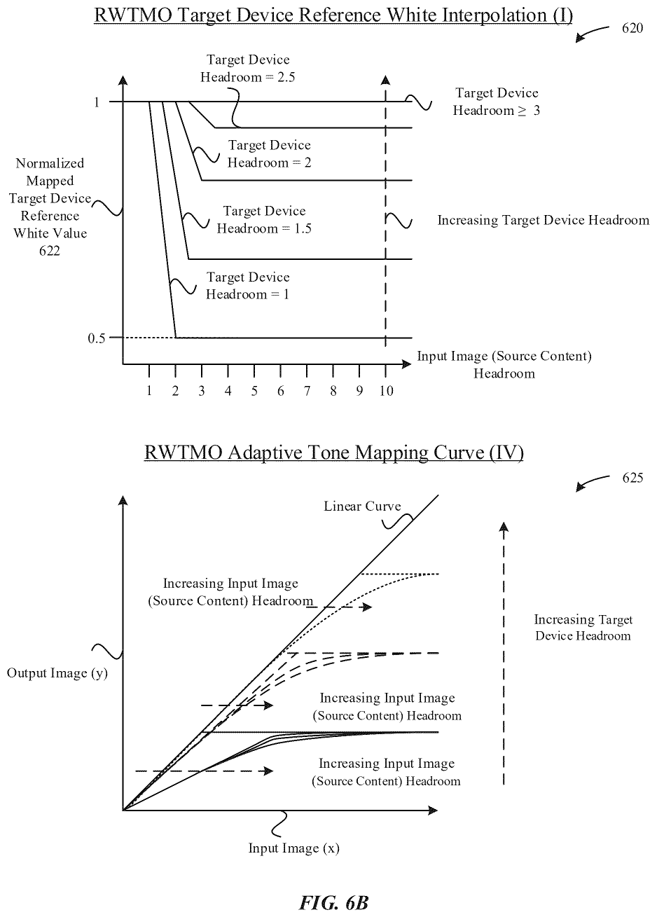

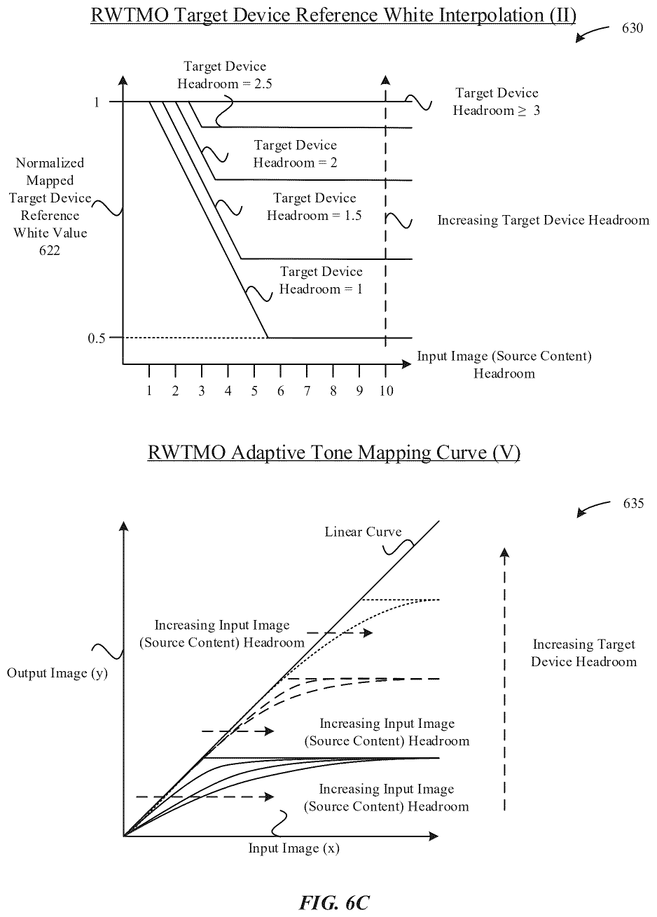

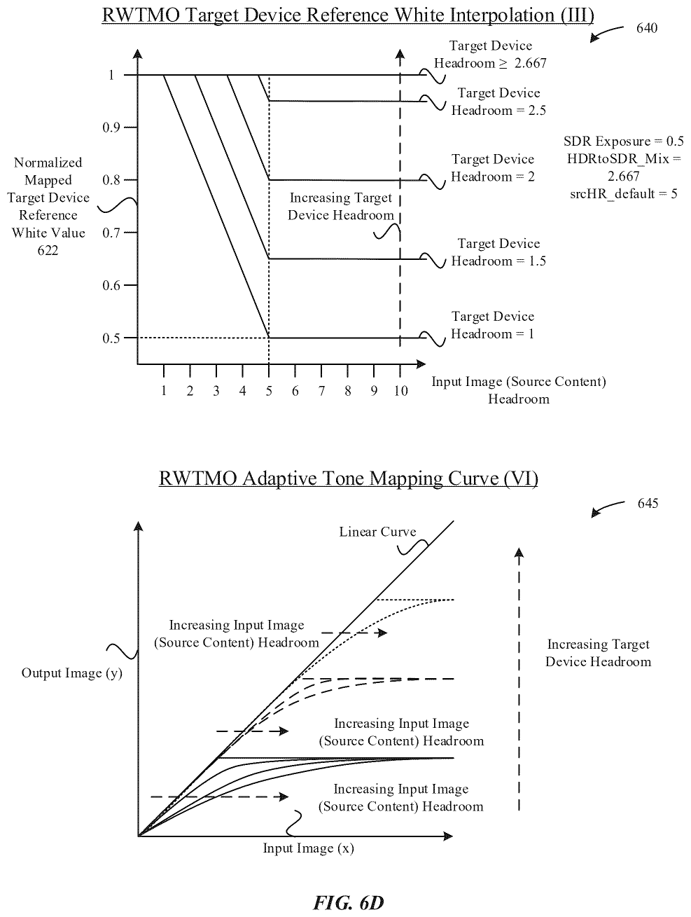

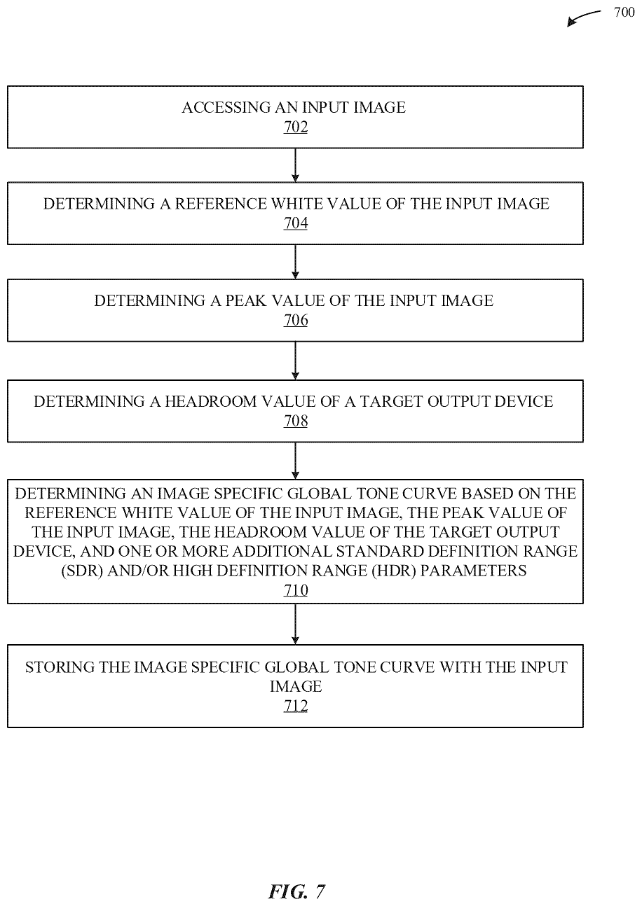

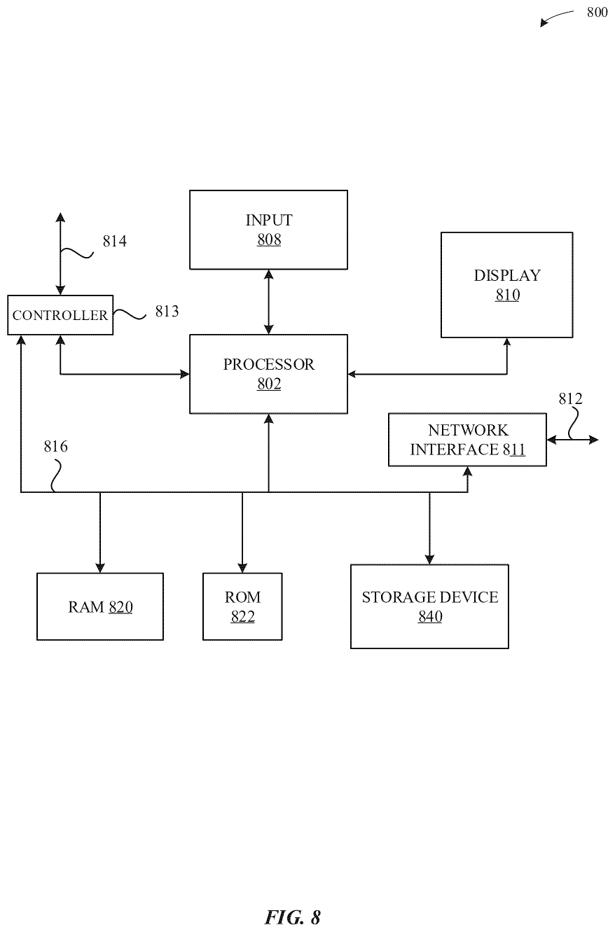

FIG. 3A illustrates diagrams 300, 305 of exemplary image specific tone mapping curves that includes a linear segment and a Bézier curve segment, where the image specific tone mapping curves are based on properties of an input image 108 and of a target device 206. The graph illustrated in diagram 300 illustrates an image specific tone curve that maps input image values 302 of the input image 108 to output image values 304 of an output image 120 formatted for the target device 206. In some embodiments, the input image values 302 can include display-referred linear luminance values for an input image 108 generated by an HDR source device, while the output image values 304 are for a limited capability HDR (e.g., more than SDR capable, less than full HDR capable) or a full capability HDR target device. The image specific tone mapping curve in diagram 300 includes a linear segment that extends from the origin point of the graph to a pivot point P₀=(P_{0,x}, P_{0,y}), where the x-axis coordinate Pox corresponds to the input image reference white value 212 of the input image 108 and the y-axis coordinate P_{0,y} corresponds to an output image reference white value. For an input image 108 provided by an HDR source, the input image reference white value 212 (P_{0,x}) can be referred to as the HDR source reference white value. For a target device 206 that provides for reproduction of more than SDR values (but less than full HDR capability), e.g., extended definition range (EDR) values, the output image reference white value (P_{0,y}) can be referred to as an EDR target device reference white value. The image specific tone mapping curve further includes a Bézier curve segment extending from the pivot point P₀ to a second point P₂=(P_{2,x}, P_{2,y}), where the x-axis coordinate P_{2,x} corresponds to an input image peak value 210 of the input image 108 and the y-axis coordinate P_{2,y} corresponds to a maximum output level 306 of the target device 206 to which the output image 120, generated from the input image 108 by the RWTMO module 204 using the image specific tone mapping curve, is to be provided for reproduction. For an input image 108 provided by an HDR source, the input image peak value 210 can be referred to as the HDR source peak luminance. The Bézier curve segment is further defined based on a control point P₁, which can be determined as a linear extrapolation of the linear segment from the pivot point P₀ to the maximum output level 306, i.e., P_{1,x}=P_{0,x}·(P_{1,y}/P_{0,y}). The Bézier curve segment provides soft clipping when mapping highlight values above the input image reference white value P_{0,x} to accommodate maximum display limitations of the target device 206. The Bézier curve segment illustrated is a second-order Bézier curve with a shape defined by the two end points P₀ and P₂ and the control point P₁. Beyond the second end point P₂, the image specific tone mapping curve maps (clamps) all input image values 302 above P_{2,x} to the maximum output level 306 P_{2,y}. In an alternative approach, clamping can be performed after RGB scaling is performed, as shown in additional formulations described herein with regard to FIG. 31. As further illustrated by the diagram 305, a normalized n^{th} order Bézier function can be defined as the following.

$${B}_{N} ( t ) = {\sum }_{ρ = 0}^{N} ( [ \begin{matrix}N \\ ρ\end{matrix} ] ) \cdot {t}^{ρ} \cdot {( 1 - t )}^{N - ρ} \cdot {P}_{ρ} for 0 \leq t \leq 1$$

Exemplary second order (quadratic) Bézier functions are illustrated in diagram 305 of FIG. 3A, where for the same end points P₀ and P₂, the shape of the curve changes based on the x-axis coordinate of the control point P₁.

FIG. 3B illustrates a diagram 310 of a generalized tone mapping curve that maps normalized input image values (labeled “s”) to normalized output image values F_{N}(s), where the generalized tone mapping curve is defined in the standard ST 2094:40. The generalized tone mapping curve includes a linear segment from the origin to a knee point K=(K_{S}, K_{F}) and an N^{th} order Bézier curve segment that implements soft clipping above the knee point K=(K_{S}, K_{F}) to the normalized end point (1,1). The generalized tone mapping curve of FIG. 3B can be defined as the following.

$${F}_{N} ( s ) = \{ \begin{matrix}\frac{{K}_{F}}{{K}_{S}} \cdot s & for 0 \leq s \leq {K}_{S} \\ {K}_{F} + ( 1 - {K}_{F} ) \cdot {B}_{N} ( t ) & for {K}_{S} \leq s \leq 1\end{matrix} \\ t = \frac{s - {K}_{S }}{1 - {K}_{S}}$$

Notably, the standard ST 2094:40 does not define how to parameterize the Bézier curve segment or the knee point K or how to base the tone mapping curve on properties of the input image and the target device as described herein.

FIG. 3C illustrates a diagram 325 where a “regular” normalization formulation is applied to Bézier curve segments for different y-axis values for the control point P₁ and corresponding different y axis values for the end point P₂, with identical x axis values for the end point P₂, i.e., the same input image peak value P_{2,x} but moving the control point P₁ vertically. The Bézier curve segment of the tone mapping curve changes shape based on the P_{1,y} value but is independent of the P_{1,x} value. The linear segment below P₀ is also fixed. The tone mapping curve shown in FIG. 3C does not adapt to differences between a target device headroom value 218 (ratio of target device maximum light level and reference white level) and an input image headroom value (ratio between input image peak value 210 and an input image reference white value 212). The image specific tone mapping curve described herein aims to provide an improved normalization that depends on the properties of the input image 108 and the target device 206 in addition to other parameters.

FIG. 3D illustrates diagrams 330, 335 regarding an alternative normalization based on inversion of quadratic Bézier curves. The Bézier inversion normalization formulation can be defined as the following:

$$\begin{matrix}y = B ( t ) \\ = B ( F ( x ) ) \\ = {B}_{P 0 , y , P 1 , y , P 2 , y} ( {B}_{P 0 , x , P 1 , x , P 2 , x}^{- 1} ( x ) )\end{matrix}$$

$$where t = {B}_{P 0 , x , P 1 , x , P 2 , x}^{- 1} ( x )$$

The normalization of “t”, in the above equation, directly depends on P_{1,x}, and when a target device headroom value 218 equals an input image headroom value, the tone mapping curve provides a perfect inversion with linear scaling. In some cases, soft clipping can be more aggressive and allows for stacking of multiple Bézier curve functions. The diagram 335 in FIG. 3D illustrates variations in a normalized Bézier inversion output values for t=B⁻¹(x) at different headroom values of an input image (source content headroom values). The y-axis corresponds to normalized Bézier inversion output values, while the x-axis corresponds to input image values. For increasing values of the x-axis coordinate of the P₁ control point, i.e., increasing P_{1,x} values, a resulting tone mapping curve can change from a more aggressive roll off curve to a less aggressive roll off curve.

FIG. 3E illustrates an additional diagram 340 regarding the alternative normalization based on inversion of quadratic Bézier curves. A quadratic Bézier curve segment of a tone mapping curve changes shape based on a target device headroom value (which corresponds to the y-axis value of the P₁ control point). With increasing P_{1,y} values (increasing target device headroom values), and for an identical P_{0,y} value (fixed input image headroom value), the shape of the quadratic Bézier curve changes, e.g., rises more steeply to a higher maximum target device output image value.

FIG. 3F illustrates a diagram 345 of various curves for determining a particular parameter for the RWTMO module 204, namely an internal parameter that corresponds to a normalized target device reference white (targRefWt) value. The targRefWt value can correspond to the P_{0,y} value for a tone mapping curve that includes a Bézier curve segment. The targRefWt value can also correspond to a scaling factor for a compressor variant of the RWTM O module 204 discussed further herein. The targRefWt value can be determined based on additional parameters, including an SDR exposure parameter 214 value, an HDR to SDR mix parameter 216 value, and the target device headroom using the following equation where targHR refers to the target device headroom.

$$targRefWt = min ( SDR\_Exposure + HDR to SDR\_Mix \cdot ( targHR - 1 ) , 1 )$$

Values for the SDR Exposure parameter 214 and the HDR to SDR mix parameter 216 can be provided or derived. In some cases, a value for the SDR exposure parameter 214 is provided as a fixed (or configurable) metadata value (e.g., with an input image file) or as a user-configurable value. In some cases, a value for the SDR exposure parameter 214 is derived. Similarly values for the HDR to SDR mix parameter 216 can be provided or derived. In some cases, a value for the HDR to SDR mix parameter 216 is provided as a fixed (or configurable) metadata value (e.g., with an input image file) or as a user-configurable value. In some cases, a value for the HDR to SDR mix parameter 216 is derived. Equations to assist with deriving values for the SDR exposure parameter 214 and the HDR to SDR mix parameter 216 include the following where srcHR refers to the source content headroom.

$$SDR\_Exposure = 1 - min ( ( srcHR - 1 ) / ( srcHR\_default - 1 ) , 1 ) \cdot SDR\_Exposure \_default$$

$$HDR to SDR\_Mix = ( 1 - SDR\_Exposure ) / ( minTargHRNoMix - 1 )$$

In some embodiments, the SDR exposure parameter 214 is a normalized parameter in a range from zero to one. In some embodiments, the HDR to SDR mix parameter 216 is a normalized parameter in a range from zero to one. In some embodiments, a value for the SDR exposure parameter 214 is provided and a value for the HDR to SDR mix parameter 216 is provided. In some embodiments, a value for the SDR exposure parameter 214 is provided and a value for the HDR to SDR mix parameter 216 is derived. In some embodiments, a value for the HDR to SDR mix parameter 216 is provided and a value for the SDR exposure parameter is derived. In some embodiments, values for both the SDR exposure parameter 214 and the HDR to SDR mix parameter 216 are provided. In some embodiments, values for both the SDR exposure parameter 214 and the HDR to SDR mix parameter 216 are derived.

A headroom value for the source content (srcHR) can be provided, e.g., with the source content (input image file), or can default to a particular value, e.g., 1000/203=4.93, where a default peak value of 1000 can be used for the source content (input image) srcPeak and a default reference white value of 203 can be used for source content (input image) reference white srcRefWt. A headroom value for the target device (targHR) can be required to be provided (in order to determine an applicable tone mapping curve for generating an output image for reproduction by the target device from an input image). When the headroom value for the target device (targHR) equals one, which can correspond to an SDR only display, the HDR to SDR mix parameter 216 can be not used (not applicable for the case when targHR=1). When the headroom value for the target device (targHR) exceeds one, both the SDR exposure parameter 214 and the HDR to SDR mix parameter 216 can be used.

When an SDR exposure parameter 214 is provided (e.g., included with an input image or configured by a user) and the target device headroom value targHR equals one, which indicates the target device can be an SDR only device, the normalized target device reference white value targRefWt can equal the value of the SDR exposure value 214 that is provided. When an SDR exposure parameter 214 is not provided and the target device headroom value targHR equals one, which indicates the target device can be an SDR only device, the normalized target device reference white value targRefWt can bet set to a base value, targRefWtBase, such as 0.5. In some cases, an algorithm can be used to compute a value for the SDR exposure parameter 214 (or for targRefWt) based on the source content (input image) headroom value srcHR. This derivation can correspond to the lowest curve in the diagram 345 of FIG. 3F. Note that for the case of an SDR only target device (targHR=1), the HDR to SDR mix parameter 216 has no effect. When values for neither the SDR exposure parameter 214 nor the HDR to SDR mix parameter 216 are provided and the target device headroom value targHR exceeds one, then multiple algorithms can be used to determine a normalized target device reference white value targRefWt, where a first algorithm can be used to determine a computed value for the SDR exposure parameter 214, and a second algorithm can be used to determine a computed value for the HDR to SDR mix parameter 216. When a value for the SDR exposure parameter 214 is provided (e.g., included with an input image or configured by a user) and the target device headroom value targHR exceeds one, and a value for the HDR to SDR mix parameter 216 is not provided, then an algorithm can be used to determine a value for the HDR to SDR mix parameter 216. A value for the normalized target device reference white value targRefWt can also be determined using one or more equations (and/or algorithms). Finally, when values for both the SDR exposure parameter 214 and the HDR to SDR mix parameter 216 are provided and the target device headroom value targHR exceeds one, a value for the normalized target device reference white value targRefWt can also be determined using one or more equations (and/or algorithms).

For the SDR exposure parameter 214, we can derive the following, where SDR_Exposure_default is the lowest source content (input image) headroom value srcHR at which the SDR exposure parameter 214 value is determined to equal the targRefWtBase value, which can be configured, for example to equal 0.5 as shown in FIG. 3F.

$$targRefWt = min ( SDR\_Exposure + HDR to SDR\_Mix \cdot ( targHR - 1 ) , 1 ) \\ SDR\_Exposure = 1 - min ( ( srcHR - 1 ) / ( srcHR\_default - 1 ) , 1 ) \cdot SDR\_Exposure \_default \\ SDR\_Exposure = 1 - min ( srcHR - 1 ) / ( srcHR\_default - 1 ) , 1 ) \cdot targRefWtBase$$

$$SDR\_Exposure = 1 - min ( ( srcHR - 1 ) / ( 5 - 1 ) , 1 ) \cdot ( 1 - 0.5 )$$

where srcHR_default=5, targRefWtBase=0.5
   Algorithmic derivation of a value for the SDR exposure parameter 214 has the following constraints.
if srcHR≥srcHR_default then SDR_Exposure=targRefWtBase
if srcHR<srcHR_default then Interpolate between SDR_Exposure and 1
if srcHR=1 then SDR_Exposure=1

For the HDR to SDR mix parameter 216, we can derive the following, where minTargHRNoMix is the lowest target device headroom value at which the target device reference white value targRefWt is set to one (and all values higher of targRefWt will also be set to one). The HDR to SDR mix parameter 216 is an offset that gradually reduces the influence of the SDR exposure parameter 214.

$$targRefWt = min ( SDR\_Exposure + HDR to SDR\_Mix \cdot ( targHR - 1 ) , 1 )$$

$$HDR to SDR\_Mix = ( 1 - SDR\_Exposure ) / ( minTargHRNoMix - 1 ) = ( 1 - 0.5 ) / ( 2.6667 - 1 )$$

Algorithmic derivation of a value for the HDR to SDR mix parameter 216 should achieve the following for the HDRtoSDR_Mix·(targHR−1) term.

$$\begin{matrix}if targHR = 1 then no impact ( regardless of the value of HDRtoSDR\_Mix ) \\ if targHR = min TargHRNoMix then HDRtoSDR\_Mix \cdot ( targHR - 1 ) = ( 1 - SDR\_Exposure )\end{matrix}$$

In some embodiments, the RWTMO module 204 is designed to keep a linear one-to-one mapping up to the pivot point P₀ and to provide for soft clipping of highlight values to adapt to remaining available headroom of the target device for input values above the reference white (SDR luminance) value of the target device.

When the target device headroom has a value of one, there is no room to map specular highlights, and the tone mapping curve would revert to hard clipping. To overcome this issue, the RWTMO module 204 adjusts the tone mapping curve based on the SDR exposure parameter 214, which can represent a normalized value from 1 down to a fractional base value. For a fixed input image headroom value (ratio of input image peak value 210 to input image reference white value 212), the SDR exposure parameter 214 increases with increasing P_{1,y} values (increasing target device headroom values 218). With less target device headroom, the SDR exposure parameter scales down (less than one, and more aggressively as target device headroom decreases) the input image values to allow for more room to map highlight values to a target device with limited dynamic range, e.g., an SDR only target device or a limited capability HDR target device.

FIGS. 3G and 3H illustrate diagrams 350, 355, and 360 of image specific tone mapping curves generated by the RWTM O module 204 that vary based on properties of the input image 108 and/or the target device 206. In diagram 350, the tone mapping curve changes shape based on changes to the P_{0,y} value (corresponding to variations in headroom of the input image 108, or source content). The slope of the tone mapping curve decreases (at a given input image value x) for increasing P_{0,y} values (increasing headroom values of the input image 108), and therefore the tone mapping curve approaches the limiting maximum value more slowly. This change allows for soft clipping as the headroom value of the input image approaches one (corresponding to the reference white value 212 of the input image approaching the peak value 210 of the input image 108). In diagram 355, the tone mapping curve changes shaped based on changes to the P_{1,y} value (corresponding to variations in headroom values of the target device 206). The tone mapping curve rises more steeply with increasing P_{1,y} values for identical P_{0,y} values at a given input image value x. With increasing headroom available in the target device 206, the tone mapping curve can accommodate a greater range of mapping for the same input image 108. In diagram 360, both changes illustrated in diagrams 350 and 355 are put together to indicate how different headroom values of the input image 108 (variable source content headroom) and different headroom values of the target device 206 change the shape and position of the tone mapping curve generated by the RWTMO module 204.

FIG. 31 illustrates a diagram 365 of an example of extending a RTMO tone mapping curve to map values above a peak output image (target device) normalized value of one. As discussed previously for FIG. 3A, input image values 302 above an input image peak value can be clamped (and therefore mapped) to a maximum peak output image (target device) value 304. The solid line at the normalized output image value of 1.0 indicates a tone mapping curve with clamping applied above an assumed input image peak value. Extending the tone mapping curve beyond the input image (source content) peak value, as indicated by the dashed line above the solid clamped curve line, can provide benefits for image processing when there is detail information above the input image (source content) peak value that need to be preserved. For example, when an input image (source content) does not provide metadata and a default input image (source content) peak value is selected (i.e., no input image peak value is provided), the default (selected) input image (source content) peak value may be lower than the actual maximum peak value of the input image. In some cases, at least one color channel, e.g., a red (R), green (G), or blue (B) color channel can include a value that exceeds the selected default input image peak value. Allowing the RWTMO tone mapping curve to extend (and continue) above the default input image peak value can allow for tone mapping of input image channel values that exceed the default input image peak value. This can result in more consistent tone mapping for a color channel that does not exceed an actual (rather than default) input image peak value. In some cases, highlight details that are suppressed when using a RWTM O tone mapping curve with clamping are preserved when using an extended RWTM O tone mapping curve.

FIG. 3J illustrates a diagram 370 of exemplary tone mapping curves using an RWTM O compressor module 254 variant. The tone mapping curve generated by the compressor module 254 maps input image (source content) values to (normalized) output image values based on properties of the input image, properties of the target device to which the output image is to be sent for reproduction, and on one or more additional internal parameters. An example internal parameter is a window value that balances a trade-off between specular highlights and diffuse highlights for the resulting tone mapping curve. The tone mapping curve illustrated in FIG. 3J includes four distinct regions that depend on the parameters: i) a linear region, ii) a curved soft compression region (which can be based on a Bézier curve in some embodiments), iii) a linear hard compression region, and iv) an optional clamp region. When the optional clamp region is excluded, the linear hard compression region can continue to be used for those input image values. The tone mapping curve generated by the compressor module 254 can be summarized by the following equation when the optional clamping region is included.

$$y = T C ( x ) = \{ \begin{matrix}L ( x ) & 0 < x \leq pivot \\ S ( x ) & pivot < x \leq pivot + window \\ H ( x ) & pivot + window < x \leq maxInput \\ max Output & maxInput < x\end{matrix}$$

The tone mapping curve generated by the compressor module 254 can be summarized by the following equation when the optional clamping region is excluded.

$$y = T C ( x ) = \{ \begin{matrix}L ( x ) & 0 < x \leq pivot \\ S ( x ) & pivot < x \leq pivot + window \\ H ( x ) & pivot + window < x \\ & \end{matrix}$$

Exemplary equations for pixel processing using the compressor module 254 are as follows.

$$[ \begin{matrix}{R}_{edr} \\ {G}_{edr} \\ {B}_{edr}\end{matrix} ] = [ \begin{matrix}{R}_{lin} \\ {G}_{lin} \\ {B}_{lin}\end{matrix} ] \cdot \frac{targRefWt}{S o u rceReferenceWhite}$$

$$x = max RGB = max ( {R}_{edr} , {G}_{edr} , {B}_{edr} )$$

$$max {RGB}_{t m o} = T C ( x ) = \{ \begin{matrix}x & 0 < x \leq targRefWt \\ x - f \cdot {( x + b )}^{2} & targRefWt < x \leq pivot + width \\ T + \frac{x - T}{R} & pivot + width < x \leq input \\ targHR & input < max RGB\end{matrix}$$

$$[ \begin{matrix}{R}_{tmo} \\ {G}_{tmo} \\ {B}_{tmo}\end{matrix} ] = [ \begin{matrix}{R}_{edr} \\ {G}_{edr} \\ {B}_{edr}\end{matrix} ] \cdot \frac{max {RGB}_{tmo}}{max RGB}$$

An alternative formulation of exemplary equations for pixel processing using the compressor module 254 are as follows. The windowPercentage parameter balances a trade-off between lower valued highlights and higher valued highlights. A default windowPercentage parameter value of 31% can be used to approximate the compressor module 254 vis-à-vis the RWTMO module 204.

$$width = ( srcHR - targRefWt ) * windowPercentage$$

$$T = targRefW t + \frac{widt h}{2}$$

$$R = \frac{src HR - threshold}{targ HR - threshold}$$

$$f = \frac{1 - \frac{1}{ratio}}{2 \cdot width}$$

$$[ \begin{matrix}{R}_{edr} \\ {G}_{edr} \\ {B}_{edr}\end{matrix} ] = [ \begin{matrix}{R}_{lin} \\ {G}_{lin} \\ {B}_{lin}\end{matrix} ] \cdot \frac{targRefWt}{S o u rceReferenceWhite}$$

$$x = max RGB = max ( {R}_{edr} , {G}_{edr} , {B}_{edr} )$$

FIGS. 4A, 4B, and 4C illustrate examples of tone mapping curves that can vary based on different values of an SDR exposure parameter 214 and based on different peak values for input images (source content). In some cases, the SDR exposure parameter 214 can be provided (or configured) as metadata (input to the RWTMO module 204), while in other cases the SDR exposure parameter 214 can be determined by the RWTM O module 204 based on an algorithm. The SDR exposure parameter 214 value indicates how to scale input image values, e.g., HDR content of an input image 108, to allow the tone mapping curve to gradually roll off (soft clip) highlights of the input image 108 above a reference white level. In some embodiments, the SDR exposure parameter 214 can vary between a value of 0 (0%) and 1 (100%).

FIG. 4A illustrates diagrams 400, 405 when an SDR exposure parameter 214 value is provided (or configured) as metadata. In diagram 400, for a metadata provided (configured) SDR exposure parameter 214 having a value of 100%, there is no scaling of the tone mapping curve. Different input image peak values result in the same tone mapping curve. For an input image with a peak value A, which does not exceed the target device diffuse white level, the input image can be mapped linearly (one-to-one) between values from the input image 108 to values for the output image 120. For an input image with peak values of B or C, which both exceed the target device diffuse white level, the input image value is mapped linearly for values up to the target device diffuse white level and clamped to the target device diffuse white level for higher input image values. When an SDR exposure parameter 214 value is provided (e.g., default value used, user configured, software configured) and not computed dynamically, tone mapping curves are scaled in an identical manner.

In diagram 405, for a metadata provided (configured) SDR exposure parameter 214 having a value of 50%, there are two different resulting tone mapping curves that include scaling. When the peak value of the input image (source content), after scaling by 50%, does not exceed the target device diffuse white level, e.g., up to peak value A or peak value B, the input image can be mapped linearly (one-to-one) between scaled values of the input image 108 to values for the output image 120. This tone mapping curve corresponds to the thick solid line indicated by peak value A or B in diagram 405. When the input image has a peak value C, which exceeds the target device diffuse white level, the resulting tone mapping curve can include a linear portion (along the same scaled linear segment as in peak values A or B) followed by a soft clipping portion indicated by the thick dashed line in diagram 405.

FIG. 4B illustrates diagrams 410, 415 when an SDR exposure parameter 214 value is calculated by the RWTM O module 204, e.g., using an SDR exposure 214 derivation equation as described herein. When distinct tone mapping curves are determined, different SDR exposure parameter 214 values can be calculated for different input image (source content) headroom values. An SDR exposure parameter 214 value that is less than 100% can assist with mapping input image values above the diffuse white level, e.g., by adaptively scaling (and thereby shifting) the linear segment of the tone mapping curve to provide room for soft clipping. The SDR exposure parameter 214 equation described herein allows for adapting the SDR exposure parameter 214 value based on a value of the headroom of the input image (source content).

In the example of diagram 410, an input image with a peak value A is mapped linearly as a computed SDR exposure parameter 214 value would be 100% for the case in which all input image values do not exceed the target device diffuse white level (no need for scaling). For an input image with a peak value B or with a peak value C, room for soft clipping of highlights (higher input image values above the target device diffuse white level) is achieved by scaling the output image values (and thereby shifting the linear portion of the tone mapping curve), e.g., using a computed SDR exposure parameter 214 value of 75%. In some cases, there may be a lower limit on the computed SDR exposure parameter 214 value, e.g., no less than 75%.

With a derived the SDR exposure parameter 214 value of 50%, as shown in diagram 415, there is additional room for soft clipping for higher input image peak values, e.g., a peak value of B or C. An input image with a peak value A can require no scaling. An input image with a peak value B can be mapped linearly when scaled by the derived value of 50%. An input image with a peak value C can include both a linear segment (based on 50% scaling) and a soft clipping segment.

FIG. 4C illustrates a diagram 420 of different tone mapping curves that correspond to a range of derived SDR exposure parameter 214 values. With a derived SDR exposure parameter 214 value, the amount of scaling due to the derived SDR exposure parameter 214 can be adapted to the input image (source content) peak value (or equivalently to the amount of headroom in the input image). A linear portion can scale in slope and provide room for soft clipping to a peak value of the input image (or equivalently input image headroom value). As the peak input image (source content) value increases, the derived SDR exposure parameter 214 can be a lower percentage resulting in a shallower initial slope for the tone mapping curve followed by room for soft clipping as the tone mapping curve approaches the target device diffuse white level value.

FIGS. 4D and 4E illustrate examples of adaption of tone mapping curves based on different values of a combination of an SDR exposure parameter 214 and an HDR to SDR mix parameter 216. The HDR to SDR mix parameter 216 indicates how to change (e.g., reduce) the effect of the SDR exposure parameter value 214 on the tone mapping curve as the target device headroom 218 value changes (e.g., increases). With additional target device headroom 218, the tone mapping curve can accommodate a greater range of input image 108 values. When the target device headroom 218 value equals one, there is no room for mapping highlight values of the input image 108 that are above the diffuse white level of the target device 206. As shown by a first example in diagram 430, the linear segment of the tone mapping curve can be scaled based on the SDR exposure value to allow for soft clipping (rather than hard clipping) of input image 108 values above the diffuse white level of the target device 206. An internal parameter referred to as minTargHRNoMix (which can be related to the HDR to SDR mix parameter 216) can have a value of 1 for the first example. As the target device headroom 218 value increases, there is additional room for soft clipping when mapping input image values above the diffuse white level to corresponding output image values. The SDR exposure parameter 214 value that scales the tone mapping curve is only used when the target device headroom 218 value is one, as there is no room for soft clipping of highlights in this case.

As further illustrated by a second example in diagram 440, the tone mapping curve is scaled based on a smaller (less than one) SDR exposure parameter 214 value, when the target device headroom falls within a range from 1 to 2. For the second example, the internal parameter minTargHRNoMix can have a value of 2. An SDR exposure parameter 214 value of one can be used when the target device headroom 218 value is greater than or equal to 2. As additionally illustrated by a third example in diagram 450, the tone mapping curve can be scaled by an even smaller SDR exposure parameter 214 value, when the target device headroom falls within a range from 1 to 3. For the third example, the internal parameter minTargHRNoMix can have a value of 3. An SDR exposure parameter 214 value of one can be used when the target device headroom 218 value is greater than or equal to 3.

By adjusting the SDR exposure parameter 214 value and the HDR to SDR mix parameter 216 value, the RWTM O module 204 can generate an image specific global tone curve that accounts for input image 108 properties (e.g., reference/diffuse white level, peak white level, headroom) and properties of the target device 206 (e.g., headroom) to allow for gradual soft clipping of highlight values of the input image above the target device reference/diffuse white level. A variety of shapes for the image specific global tone curve can be generated based on different input images 108 and different target devices 206, including both a linear segment and a curved segment. In some embodiments, the curved segment is based on a second order Bézier function.

FIG. 5A illustrates a diagram 500 of exemplary processing of input images (e.g., HDR input images) by a RWTM O module 204 to generate SDR output images suitable for reproduction at an SDR target device 206, e.g., an SDR only capable display. The RWTMO module 204 generates tone curves to map values of an HDR input image 508, obtained from a source device 202, to values of an SDR output image 510, to be reproduced on the target device 206. The RWTMO module 204 can generate a tone curve that accounts for properties of the HDR input image 508, e.g., an input image peak value 210 and an input image reference white value 212. The RWTMO module 204 can further generate the tone curve based on an SDR exposure value 214, which can be provided, configured, or derived. While the SDR exposure value 214 is described as providing room for mapping highlights of an HDR image for display by an SDR (or limited capability HDR) target device, the effect of the SDR exposure value 214 can also be used to alter the values of an image before providing for reproduction by the target device 206.

FIG. 5B illustrates diagrams 520, 530 of examples of tone curves generated by an RWTMO module 204 to provide adaptive tone mapping of HDR input image values to normalized SDR image output values for derived SDR exposure values based on different values for a targRefWtBase parameter. With a targRefWtBase value of 50%, for increasing peak values of the HDR input image, the tone mapping curve increases more slowly, while with a targRefWtBase value of 75%, the tone mapping curve increases more quickly for increasing peak values of the HDR input image. Note that with a targRefWtBase value of 100% (corresponding to an SDR exposure value fixed at 100%), the tone mapping curve consists of only the linear curve segment followed by hard clipping. The tone mapping curve generated by the RWTM O module 204 can be used to provide for soft clipping of HDR input image values that are above the HDR image reference white level, with lower SDR exposure values providing additional room for soft clipping.

FIG. 5C illustrates a diagram 540 of a particular concrete example of an SDR tone mapping curve 542 using the ideas described herein by an RWTM O module 204. With an input image value of 1000, an input image reference white value of 203, and an SDR exposure value of 0.5 (50%), a static equation for the SDR tone mapping curve 542 generated by the RWTM O module 204 can be expressed as the following.

$${E}_{t m o} = \frac{E}{{L}_{w}} \cdot \frac{B ( {B}^{- 1} ( x ) )}{max ( RGB )} \qquad E = R , G , or B$$

$$t = {B}^{- 1} ( x ) = \frac{\sqrt{a x + b} + c}{a} = \frac{\sqrt{1.92 61 * x - 0.9 \; 261} - 1}{1.9261}$$

Where a simplified Bézier curve equation, for the special case when P_{1,y}=P_{2,y} is as follows.

$$y = B ( t ) = {P}_{1 , y} + {( 1 - t )}^{2} \cdot ( {P}_{0 , y} - {P}_{1 , y} ) = 0.5 + {( 1 - t )}^{2} \cdot ( 0. 5 - 1 )$$

The simplified Bézier curve equation above can be derived from a 2^{nd} order version of the general normalized n^{th} order function.

$${B}_{N} ( t ) = {\sum }_{ρ = 0}^{N} ( [ \begin{matrix}N \\ ρ\end{matrix} ] ) \cdot {t}^{ρ} \cdot {( 1 - t )}^{N - ρ} \cdot {P}_{ρ} \qquad for \qquad 0 \leq t \leq 1$$

The tone mapping curves generated by a RWTM O module 204, as described herein, can be based on three parameters that account for properties of an input image 108, e.g., an input image peak value 210 and an input image reference white value 212, and at least one property of a target device 206, e.g., a target device headroom value 218. The RWTMO module 204 can further determine a tone mapping curve based on one or more configurable and/or derived parameters 222, such as an SDR exposure parameter 214 value and/or an HDR to SDR mix parameter 216 value. In some embodiments, the RWTM O module 204 generates a parametric global tone mapping curve that includes a linear segment and a curved segment. In some embodiments, the curved segment is a Bézier curve segment with a set of control points, and parametric normalization for the global tone mapping curve uses an invert Bézier normalization function. The RWTM O module 204 can generate global tone mapping curves for a range of target device capabilities, e.g., accommodating SDR only displays, limited capability HDR displays, and full capability HDR displays (the last requiring only a linear mapping).

In some cases, the global tone mapping curve is adapted to the content of the input image 108 using content statistics. For example an input image peak value 210 can be a maximum value, which can be referred to as a content light level (CLL), or can be a 99.9 percentile level, where values of 99.9 percent of the pixels of the input image 108 fall below the 99.9 percentile level, or can be a 99 percentile value. Similarly, the input image reference white value 212 can be represented as a 90 percentile level, where values of 90 percent of the pixels of the input image 108 fall below the 90 percentile level, or can be an 80 percentile level. In some embodiments, the input image reference white level 212 can be represented as a 50 percent distance between an average light level (ALL) of the input image 108 and the input image peak value 210. In some embodiments, the SDR exposure value 214 is determined as a ratio between the ALL and the input image reference white level 212. In some embodiments, the SDR exposure parameter value 214 can be a 50 percentile level, where values of 50 percent of the pixels of the input image 108 fall below the 50 percentile level. In some embodiments, the HDR to SDR mix parameter value 216 is determined as a ratio between the input image peak value 210 and the input image reference white value 212 weighted by the SDR exposure value 214.

FIG. 6A illustrates diagrams 600, 615 of a generic tone mapping curve that includes a linear region 612, in which a range of input image values 302 are mapped to normalized output image values 604 via a linear segment, and a soft clipping region 614, in which a range of input image values 302 are mapped to normalized output image values 604 via a soft clipping curve. A reference white value L_{w} 608 can be mapped to a normalized mapped output (target device) value 606, e.g., 0.5 as shown, and determine the linear region 612. An input image peak value Lc 610 can be mapped to a normalized maximum output (target device) level 602, e.g., 1.0 as shown. The reference white value L_{w} 608 can be fixed to a given value, and mid-tone and shadow values (below the reference white value L_{w} 608) can have a predictive mapping (linear scaling) based on the reference white value L_{w} 608. The generic tone mapping curve can be defined by the following equation.

$$y = T C ( x ) = \{ \begin{matrix}Linear ( x ) & 0 < x \leq {L}_{w} \\ SoftClip ( x ) & {L}_{w} < x \leq {L}_{c} \\ 1 & {L}_{w} < x\end{matrix}$$

Metadata associated with the input image (source content) and the target device can determine (in part) the shape of the generic tone mapping curve. Exemplary metadata includes an input image (source) peak value (a maximum value of an input signal to be considered), an input image (source) reference white value (a value below which the generic tone mapping curve should be linear), and an output image (target device) mapped reference white value (a value at which an HDR reference white value is mapped). The generic tone mapping curve can be constrained to required that the HDR reference white value is no more than the input image (source) peak value, and that the output image (target device) mapped reference white value is no more than 1 (normalized by the input image reference white value). In some cases, default values for metadata can be used, e.g., a default input image (source) peak value of 1000, an input image (source) reference white value of 203, and an output image (target device) normalized mapped reference white value of 0.5. In some cases, selection of the particular output image (target device) normalized mapped reference white value to use can be optimized based on an amount of input image (source) headroom and an amount of output image (target device) headroom. Headroom values can be determined as a ratio between a peak value and a reference white value and can be no less than one. For example, input image (source) headroom srcHr=SourcePeak/HDRSourceReferenceWhite, and output image (target device) headroom targHr=TargeDevicePeak/TargetDeviceReferenceWhite.

FIGS. 6B, 6C, and 6D illustrate diagrams 620, 625, 630, 635, 640, 645 of examples of determining a normalized mapped output image (target device) reference white value 622 based on different values of target device headroom and on an amount of input image (source content) headroom. The normalized mapped target device reference white value 622 can be derived in various manners, including as described hereinabove regarding derivation of the SDR exposure parameter 214 as illustrated in FIG. 3F. The previous derivation can accommodate SDR exposure parameter 214 values provided via metadata (e.g., provided with an input image, preset, or user configured), while the subsequent equations in FIGS. 6B, 6C, and 6D provide a different implementation without plugging a provided SDR exposure value directly into a unified equation and instead allow for deriving the SDR exposure value in various manners. As such, additional methods to determine a target device reference white value 622 are described next.

FIG. 6B illustrates a version of determining a normalized mapped target device reference white value 622 based on headroom values. With increasing amounts of target device headroom, higher output image values can be supported, and the normalized mapped target device reference white value 622 (which maps to the input image reference white value and determines the linear region of the tone mapping curve) can increase. The resulting effect of changing the normalized mapped target device reference white value 622 according to the input image (source content) headroom and the target device headroom is shown in the adaptive tone mapping curves of diagram 625. The normalized mapped target device reference white value 622 for FIG. 6B can be determined based on headroom values using the following equations.

$$targRefWt = mapRefWt + ( 1 - mapRefWtEDR ) * ( 1 - s r cHR + targHR )$$

$$mapRefWtEDR = mapRefWt + ( 1 - mapRefWt ) * min ( \frac{t a r g H R - 1}{\frac{8}{3} - 1} , 1 )$$

The value 8/3−1=1.6667 is based on a minTargHRNoMix value of 8/3, which is the lowest target device headroom value at which mapRefWt has an effect. The min term in the second equation above is not required for an SDR only tone mapping curve (SDR input to SDR output).

FIG. 6C illustrates another version of determining a normalized mapped target device reference white value 622 based on differences in headroom values. In diagram 620 of FIG. 6B, the slopes vary for different target device headroom values, while in diagram 630 of FIG. 6C, the slopes are the same for different target device headroom values. This change results in different shapes for the corresponding adaptive tone mapping curves of diagram 635. The normalized mapped target device reference white value 622 for FIG. 6C can be determined based on differences in headroom values using the following equations.

$$targRefWt = 1 - min ( \frac{srcHR - targHR}{speed} , mapRefWtEDR )$$

$$mapRefWtEDR = ( 1 - mapRefWt ) * ( 1 - min ( \frac{t a r g H R - 1}{\frac{8}{3} - 1} , 1 ) )$$

$$speed = \frac{s r c H {R}_{default} - 1}{m a p R e f W t}$$

The value 8/3−1=1.6667 is based on a minTargHRNoMix value of 8/3, which is the lowest target device headroom value at which mapRefWt has an effect. The “(1−min)” term in the second equation above is not required for an SDR only tone mapping curve (SDR input to SDR output). The value for speed can be set to mapRefWt for default input image (source content) metadata values.

An additional version of determining a normalized mapped target device reference white value 622 can be based on differences in headroom values. The normalized mapped target device reference white value 622 can be determined based on differences in headroom values using the following equations.

$$targRefWt = 1 - min ( \frac{srcHR - targHR}{speed} , mapRefWtEDR )$$

$$mapRefWtEDR = ( 1 - mapRefWt ) * ( 1 - min ( \frac{t a r g H R - 1}{\frac{8}{3} - 1} , 1 ) )$$

$$speed = \frac{s r c H {R}_{default} - 1}{m a p R e f W t} \cdot targHR$$

The value 8/3−1=1.6667 is based on a minTargHRNoMix value of 8/3, which is the lowest target device headroom value at which mapRefWt has an effect. The “(1-min)” term in the second equation above is not required for an SDR only tone mapping curve (SDR input to SDR output). The value for speed can be set to mapRefWt for default input image (source content) metadata values.

FIG. 6D illustrates a diagram 640 another example of determining a normalized mapped target device reference white value 622 based on an SDR exposure parameter value of 0.5, an SDR to HDR mix parameter value of 8/3=2.667, and an input image (source content) headroom default value of 5.0. In this example, for target device headroom values of 2.667 or more, the normalized mapped target device reference white value 622 is 1.0 for any input image (source content) headroom value. When the target device headroom value is less than 2.667, the normalized mapped target device reference white value is a constant for image input image (source content) values of 5.0 and increases linearly below the image input image (source content) values of 5.0 to a maximum value of 1.0. All of the linear segments of the normalized mapped target device reference white value plots in diagram 640 have a constant slope, which is determined based on the SDR exposure value of 0.5. The resulting tone mapping curve associated with diagram 640 is shown in diagram 645. Increasing values of output image (target device) headroom allows for a wider range of input image (source content) values to be mapped linearly, depending on the value of the headroom of the input image (source content).

### Representative Equations

Exemplary equations used for determination of a tone mapping curve with a Bézier curve segment and pixel (image) processing are provided. Stage 1 internal parameter coefficients can be defined as follows.

$${P}_{2 , x} = srcHR$$

$$a = 1 + {P}_{2 , x} - 2 * \frac{t a r g H R}{t argRefWt}$$

$$b = {( \frac{t a r g H r}{t a r g R e f W t} )}^{2} - {P}_{2 , x}$$

$$c = 1 - {P}_{2 , x}$$

Stage 1 pixel processing can be defined as follows.

$$[ \begin{matrix}{R}_{edr} \\ {G}_{edr} \\ {B}_{edr}\end{matrix} ] = [ \begin{matrix}{R}_{lin} \\ {G}_{lin} \\ {B}_{lin}\end{matrix} ] \cdot \frac{1}{S o u rceReferenceWhite}$$

$$x = max RGB = max ( {R}_{edr} , {G}_{edr} , {B}_{edr} )$$

$$max {RGB}_{tmo} = TC ( x ) = \{ \begin{matrix}x \cdot targRefWhite & 0 < x \leq 1 \\ B ( {B}^{- 1} ( x ) ) & 1 < x \leq srcHR \\ targHR & x > srcHR\end{matrix}$$

$$[ \begin{matrix}{R}_{tmo} \\ {G}_{tmo} \\ {B}_{tmo}\end{matrix} ] = [ \begin{matrix}{R}_{edr} \\ {G}_{edr} \\ {B}_{edr}\end{matrix} ] \cdot \frac{max {RGB}_{tmo}}{max RGB}$$

Stage 2 pixel processing can be defined as follows.

$$max {RGB}_{t m o} = B ( {B}^{- 1} ( x ) ) = B ( t ) \qquad 1 < x \leq srcHR$$

$$t = {B}^{- 1} ( x ) = \frac{\sqrt{a \cdot x + b} + c}{a}$$

$$max {RGB}_{t m o} = B ( t ) = targHR + {( 1 - t )}^{2} \cdot ( targRefWt - targHR )$$

FIG. 7 illustrates a flowchart 700 of a representative method to generate an image specific global tone curve based on properties of an input image 108 and of a target device 206. The method can be performed by a computing device 102 that includes an RWTM O module 204. At 702, the computing device 102 accesses an input image 108. At 704, the computing device 102 determines a reference white value 212 of the input image 108. At 706, the computing device 102 determines a peak value 210 of the input image 108. At 708, the computing device 102 determines a headroom value 218 of a target device 206. At 710, the computing device 102 determines the image specific global atone curve based on i) the reference white value 212 of the input image 108, ii) the peak value 210 of the input image 108, iii) the headroom value 218 of the target device 206, and iv) one or more additional standard definition range (SDR) and/or high definition range (HDR) parameters. In some embodiments, one or more of the additional SDR and/or HDR parameters are provided as metadata, e.g., with the input image 108. In some embodiments, one or more of the additional SDR and/or HDR parameters are derived by the RWTM O module 204 of the computing device 102. At 712, the computing device 102 stores the image specific global tone curve with the input image 108.

In some embodiments, the method performed by the computing device 102 further includes the computing device 102: i) applying the image specific global tone curve to the input image 108 to generate an output image 120, and ii) providing the output image 120 to the target device 206. In some embodiments, the input image 108 includes an HDR image and the target device 206 includes an SDR only capable display. In some embodiments, the input image 108 includes an HDR image and the target device 206 includes an HDR display. In some embodiments, the input image 108 includes an HDR image derived from a plurality of image captures, and each image capture includes an SDR image. In some embodiments, the image specific global tone curve includes: i) a linear segment that maps input image values of the input image 108 below the reference white value 212 of the input image to output image values of the output image 120 based on a scalar function, and ii) a monotonically increasing curved segment that maps the input image values of the input image 108 above the reference white value 212 of the input image 108 to output image values of the output image 120 based on a Bézier curve function. In some embodiments, the Bézier curve function is parameterized based on i) a first point P₀ representing the reference white value 212 of the input image 108 and a corresponding reference white value of the target device 206, ii) a second point P₂ representing the peak value 210 of the input image 108 and a maximum output level of the target device 206, and iii) a third point P₁ representing a control point that determines a shape of the Bézier curve function between the first point P₀ and the second point P₁. In some embodiments, a slope of the Bézier curve function at each particular image input value and for a fixed headroom value of the input image increases for increasing headroom values 218 of the target device 206. In some embodiments, a slope of the Bézier curve function at each particular image input value and for a fixed headroom value 218 of the target device 206 decreases for increasing headroom values of the input image 108. In some embodiments, the one or more additional SDR and/or HDR parameters include an SDR exposure parameter 214 that scales the image specific global tone curve to decrease values of an output image 120 generated from the input image 108 using the image specific global tone curve when the headroom value 218 of the target device 206 falls within a particular range of values. In some embodiments, the one or more additional SDR and/or HDR parameters include an HDR to SDR mix parameter 216 that determines a rate at which changes to the image specific global tone curve due to the SDR exposure parameter 214 occur. In some embodiments, the one or more additional SDR and/or HDR parameters include an SDR exposure parameter 214 that determines scaling of HDR content of the input image 108 to provide room for mapping highlights of the input image 108 to values of an output image 120 for reproduction by an SDR only capable target device 206. In some embodiments, the one or more additional SDR and/or HDR parameters include an HDR to SDR mix parameter 216 that indicates how to reduce changes to the image specific global tone curve, caused by the SDR exposure parameter 214, as the headroom value 218 of the target device 206 increases. In some embodiments, the input image 108 includes a frame of an input video, and the method further includes generating a corresponding frame of an output video based on the frame of the input video and the image specific global tone curve.

### Glossary of Terms

Pixel: a color image can be represented based on values for a set of pixels, where each pixel includes three light stimulus values, a red (R) value, a green (G) value, and a blue (B) value. Each pixel can be referred to as a pixel triplet or pixel tuple of three RGB values.

Radiometry: a technique to measure electromagnetic radiation, including visible light.

Photometry: a technique to measure an intensity of light based on its perceived brightness in accordance with the human eye.

Luminance: An absolute physical value representing photometric light associated with a determined chromaticity, where luminance can be expressed in units of candelas per square meter (cd/m2) or nits.

Luma: A perceptually encoded luminance.

Light Level: An intensity of light that usually corresponds to a channel intensity in a given color representation.

Reference White Level: A first grey level that appears to be white.

Diffuse White Level: A last white level that does not appear to emit light.

Specular Highlights: Bright objects that appear above the diffuse white level.

Dynamic Range: A range between a highest value and a lowest value. A dynamic range of an image can be expressed i) as an order of magnitude, e.g., a log 10 value of the ratio between the highest and smallest values (an HDR term), ii) as a number of stops, e.g., a log 2 value of the ratio between the highest and smallest values (a photography term), or iii) as a contrast ratio between the highest and smallest values (a display term).

Headroom: A value that can be expressed: i) as a ratio between a maximum light level and a reference light level, where a headroom value of 1 indicates that the reference light level equals the maximum light level, or ii) as a difference in stops between a maximum light level and a reference light level, where a headroom value of 0 indicates that the reference light level equals the maximum light level. For example, a ratio between 1000 (maximum light level) and 203 (reference light level) corresponds to a headroom value of 4.9626 (1000/203), while a logarithmic difference in stops log₂(1000)−log₂(203) corresponds to a headroom value of 2.3004. Similarly, a ratio between 203 (maximum light level) and 203 (reference light level) corresponds to a headroom value of 1.0, while the logarithmic difference in stops is 0.

Global Tone Mapping: An input image pixel triplet (RGB) value is always mapped to the same output pixel triplet value, e.g., using a one-dimensional curve (as discussed herein) or using a three-dimensional look-up table (LUT).

Local Tone Mapping: An input image pixel triplet (RGB) value is mapped to different output pixel triplet values depending on a surrounding context for the input image pixel triplet, e.g., based on a spatial context (such as neighboring input image pixel triplet values) and/or temporal context (such as for an input image that is a frame in a sequence of frames of a video with time-varying pixel triplet values).

### Representative Device

FIG. 8 illustrates a detailed view of a computing device 800 that can be used to implement the various techniques described herein, according to some embodiments. In particular, the detailed view illustrates various components that can be included in the computing device 102 described in conjunction with FIG. 1. As shown in FIG. 8, the computing device 800 can include a processor 802 that represents a microprocessor or controller for controlling the overall operation of the computing device 800. The computing device 800 can also include a user input device 808 that allows a user of the computing device 800 to interact with the computing device 800. For example, the user input device 808 can take a variety of forms, such as a button, keypad, dial, touch screen, audio input interface, visual/image capture input interface, input in the form of sensor data, and so on. Still further, the computing device 800 can include a display 810 that can be controlled by the processor 802 (e.g., via a graphics component) to display information to the user. A data bus 816 can facilitate data transfer between at least a storage device 840, the processor 802, and a controller 813. The controller 813 can be used to interface with and control different equipment through an equipment control bus 814. The computing device 800 can also include a network/bus interface 811 that couples to a data link 812. In the case of a wireless connection, the network/bus interface 811 can include a wireless transceiver.

As noted above, the computing device 800 also includes the storage device 840, which can comprise a single disk or a collection of disks (e.g., hard drives). In some embodiments, storage device 840 can include flash memory, semiconductor (solid state) memory or the like. The computing device 800 can also include a Random-Access Memory (RAM) 820 and a Read-Only Memory (ROM) 822. The ROM 822 can store programs, utilities, or processes to be executed in a non-volatile manner. The RAM 820 can provide volatile data storage, and stores instructions related to the operation of applications executing on the computing device 800, e.g., the image processing module 110, the tone mapping module 112, the reference white tone mapping optimization module 204, and so on.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for generating an image specific global tone curve, the method comprising, at a computing device:
accessing an input image;
determining a reference white value of the input image;
determining a peak value of the input image;
determining a headroom value of a target device;
determining the image specific global tone curve based on the reference white value of the input image, the peak value of the input image, the headroom value of the target device, and one or more additional standard-definition range and/or high-definition range parameters; and
storing the image specific global tone curve with the input image.

2. The method of claim 1, further comprising:
applying the image specific global tone curve to the input image to generate an output image; and
providing the output image to the target device.

3. The method of claim 1, wherein the input image comprises a high-definition range image and the target device includes a standard-definition range only capable display.

4. The method of claim 1, wherein the input image comprises a high-definition range image and the target device includes a high-definition range display.

5. The method of claim 1, wherein the input image includes a high-definition range image derived from a plurality of image captures that includes corresponding ones of a plurality of standard-range images.

6. The method of claim 1, wherein the image specific global tone curve comprises:
a linear segment that maps input-image values of the input image below the reference white value of the input image to output image values of the output image based on a scalar function, and
a monotonically increasing curved segment that maps the input-image values of the input image above the reference white value of the input image to output-image values of the output image based on a Bézier curve function.

7. The method of claim 6, wherein the Bézier curve function is parameterized based on a first point P₀ representing the reference white value of the input image and a corresponding reference white value of the target device, a second point P₂ representing the peak value of the input image and a maximum output level of the target device, and a third point P₁ representing a control point that determines a shape of the Bezier curve function between the first point P₀ and the second point P₂.

8. A non-transitory computer-readable storage medium configured to store instructions that, when executed by at least one processor included in a computing device, cause the computing device to generate an image specific global tone curve by carrying out steps that include:
accessing an input image;
determining a reference white value of the input image;
determining a peak value of the input image;
determining a headroom value of a target device;
determining the image specific global tone curve based on the reference white value of the input image, the peak value of the input image, the headroom value of the target device, and one or more additional standard-definition range and/or high-definition range parameters; and
storing the image specific global tone curve with the input image.

9. The non-transitory computer-readable storage medium of claim 8, wherein the image specific global tone curve comprises:
a linear segment that maps input image values of the input image below the reference white value of the input image to output image values of the output image based on a scalar function, and
a monotonically increasing curved segment that maps the input image values of the input image above the reference white value of the input image to output-image values of the output image based on a Bézier curve function.

10. The non-transitory computer-readable storage medium of claim 9, wherein the Bézier curve function is parameterized based on a first point P₀ representing the reference white value of the input image and a corresponding reference white value of the target device, a second point P 2 representing the peak value of the input image and a maximum output level of the target device, and a third point P₁ representing a control point that determines a shape of the Bézier curve function between the first point P₀ and the second point P₂.

11. The non-transitory computer-readable storage medium of claim 10, wherein a slope of the Bézier curve function at each particular image input value and for a fixed headroom value of the input image increases for increasing headroom values of the target device.

12. The non-transitory computer-readable storage medium of claim 8, wherein the one or more additional standard-definition range and/or high-definition range parameters include an standard-definition range exposure parameter that scales the image specific global tone curve to decrease values of an output image generated from the input image using the image specific global tone curve when the headroom value of the target device falls within a particular range of values.

13. A computing device configured to generate an image specific global tone curve, the computing device:
at least one processor; and
at least one memory storing instructions that, when executed by the at least one processor, cause the computing device to carry out steps that include:
accessing an input image;
determining a reference white value of the input image;
determining a peak value of the input image;
determining a headroom value of a target device;
determining the image specific global tone curve based on the reference white value of the input image, the peak value of the input image, the headroom value of the target device, and one or more additional standard-definition range and/or high-definition range parameters; and
storing the image specific global tone curve with the input image.

14. The computing device of claim 13, wherein the one or more additional standard-definition range and/or high-definition range parameters include an standard-definition range exposure parameter that determines scaling of high-definition range content of the input image to provide room for mapping highlights of the input image to values of an output image for reproduction by an standard-definition range only capable target device.

15. The computing device of claim 14, wherein the one or more additional standard-definition range and/or high-definition range parameters include an high-definition range to standard-definition range mix parameter that indicates how to reduce changes to the image specific global tone curve, caused by the standard-definition range exposure parameter, as the headroom value of the target device increases.

16. The computing device of claim 13, wherein the input image includes a frame of an input video, and wherein the steps further includes generating a corresponding frame of an output video based on the frame of the input video and the image specific global tone curve.

17. The computing device of claim 13, wherein the steps further includes:
applying the image specific global tone curve to the input image to generate an output image; and
providing the output image to the target device.

18. The computing device of claim 13, wherein the input image includes a high-definition range image and the target device includes a standard-definition range only capable display.

19. The computing device of claim 13, wherein the input image includes a high-definition range image and the target device includes a high-definition range display.

20. The computing device of claim 13, wherein the input image includes a high-definition range image derived from a plurality of image captures that includes corresponding ones of a plurality of standard-range images.
